(19) United States
(12) Patent Application Publication
(10) Pub. No.: US 2006/0253365 A1
(43) Pub. Date: Nov. 9, 2006

(54) System facilitating communications and financial contributions involving facilities and residents thereof

(76) Inventors: Eric Langshur, Chicago, IL (US); Sharon Langshur, Chicago, IL (US); Mark J. Day, Philadelphia, PA (US); Raul Vasquez, Western Springs, IL (US)

Correspondence Address: BELL, BOYD & LLOYD, LLC, PO BOX 1135, CHICAGO, IL, 60690-1135, US

(21) Appl. No.: 10/551,609

(22) PCT Filed: Mar. 29, 2004
(86) PCT No.: PCT/US04/09558

§ 371 Date: Jul. 24, 2006

Related U.S. Application Data
(60) Provisional application No. 60/460,130, filed on Apr. 3, 2003.

(51) Int. Cl. G06Q 40/00

(52) U.S. Cl. 705/37

(57) ABSTRACT

A computer system and method for facilitating communications and financial contributions related to a resident of a facility. The facility is used by an organization to support the resident. In one embodiment, the computer system includes a plurality of instructions which direct a processor operating on a network to: (a) cause a graphical user interface to prompt users to make charitable or financial contributions to the organization; (b) produce a plurality of outputs which vary with different patterns of inputs by each of the users; and (c) facilitate communications amongst the users and between the organization and the users. This type of computer system provides benefits il to relocated persons, those concerned about them and the organizations which support them.

### PRIORITY CLAIM

This application is a continuation-in-part of and claims priority to and the benefit of U.S. Patent Application Ser. No. 60/460,130, filed on Apr. 3, 2003, entitled “Interactive On-Line Communication Method,” the entire disclosure of which is hereby incorporated by reference.

### BACKGROUND OF THE INVENTION

Many circumstances require people to live apart from their family and friends for a period of time. These circumstances can arise, for example, when a person is admitted to a hospital or other health care facilities. Other circumstances may arise, for example, when a person joins the military or attends a college, a conference, a retreat or a summer camp. In some cases, the relocated person is incapacitated, inaccessible or otherwise unavailable to make regular contact with his/her family and friends for a period of time. Because of employment schedules and the time and cost of having to travel, in some cases, across country, many people find it difficult or not feasible to visit their loved ones as often as they would like.

In this situation, a close family member typically visits the relocated person and reports information back to the other concerned people. Conventionally, the visitor has reported information to others by phone, regular mail or email. This conventional method has several disadvantages. If the visitor wants to provide the others with a written status or photographs, the visitor must make a separate mailing, electronic or nonelectronic, to each of the concerned persons. This method can be time consuming, inconvenient and, in the case of nonelectronic mailing, this method can be relatively expensive.

Furthermore, this method does not provide a worldwide accessible communication channel between the organization hosting the relocated person and the concerned group of people. Without such a communication channel, it is difficult for the concerned group of people to voice their praise or concerns to the organization with respect to the relocated person. Also, without such a communication channel, it is difficult for the organization to identify the concerned group of people and to direct marketing and donation solicitations to the group. Therefore, the organization has little or no incentive to fund the cost of maintaining such a communication channel. Without this funding, it is more likely that the concerned group of people will have the burden of paying a relatively high service fee in order to use such a communication channel.

Therefore, there is a need to overcome these disadvantages for the benefit of relocated people, those concerned about them and the organizations which support them.

### SUMMARY OF THE INVENTION

The present invention relates to a computer system for a computer server. More specifically, the present invention relates to software or computer code which is used to operate online website accounts for family, friends and others who are interested in sharing information about a relocated person.

In one embodiment, the computer system of the present invention is used by one or more computer servers to operate multiple websites associated with multiple affiliated hospitals. Each website is operated by the implementer of the present invention who is functioning as an application service provider. Each hospital preferably pays the implementer for hosting a website for that hospital.

If a patient is admitted to one of these hospitals, a family member or friend of the patient can subscribe to this service by opening an account at the website. The person who opened the account, at times referred to as the manager of the account, may visit the patient, take photographs, speak to the nurses and physicians and generally gather information about the health status of the patient. The manager can then log on to the website account and upload the current health status and photographs of the patient. The manager can also invite other family members and friends throughout the world to join the website account. Those who join the account will also be able to see the photographs of the patient and stay informed on the status of the patient. Certain webpages are designated with a restricted privacy level. The manager must approve family members and friends before they can access these webpages.

In addition to enabling family and friends to share information about a patient, the computer system of the present invention enables the hospitals to exchange information with the users of the website account. For example, if a visitor at the hospital encounters a physician or nurse who has provided outstanding care, that visitor can complete a compliment form at the website and send that form to the hospital. The system also periodically sends prompts to the users, such as prompts to make a compliment, complete a survey of the hospital and make a donation to the hospital.

In one embodiment, the computer system includes an output control function which correlates the timing of the prompts to the user's historical on-line behavior or activities. In one embodiment, this timing function of the system is configured to increase user participation, involvement, communication and donation levels based upon known behavioral patterns and factors. Therefore, the computer system not only provides channels of communications between users and the hospitals, but the system also increases user response and stimulates communications and donations by the users.

The present invention, in one embodiment, includes a computer system which provides users with a website account to share information about hospitalized friends, relatives and other loved ones. The users can also use this website account to communicate with hospitals which care for the patient. Furthermore, the system provides hospitals with an online method for: (a) prompting donations from the users; (b) promoting, branding and marketing their health care services; and (c) communicating with users to increase the quality of service and enhance the operations of the hospitals.

It is therefore an object of the present invention to provide a system facilitating communications and financial contributions involving facilities and residents thereof.

Another object of the present invention is to assist family, friends and others in staying up-to-date on the condition of relocated persons.

Yet another object of the present invention is to provide hospitals and other organizations with a method of marketing their products and services to a target consumer group of family, friends and others affiliated with relocated persons such as hospitalized patients.

Still another object of the present invention is to increase the flow of communications amongst affiliates of relocated persons and between the affiliates and the organizations which support the relocated persons.

Another object of the present invention is to provide hospitals and other organizations with a method of enhancing the quality of their services and products.

Still another object of the present invention is to provide hospitals and other organizations with a communication channel for soliciting funding and donations from a select pool of potential donators.

Yet another object of the present invention is to assist hospitals and other organizations in identifying people who have a relatively high probability of making donations to the hospitals and other charitable organizations.

Another object of the present invention is to increase the responsiveness of users to opportunities presented on-line for providing donations, funding and information to hospitals and other charitable organizations which provide services to relocated persons.

Still another object of the present invention is to assist non-health care companies in enabling their employees and customers to access the system of the present invention through use of the companies' websites.

Additional features and advantages of the present invention are described in, and will be apparent from, the following Detailed Description of the Invention and the figures.

### BRIEF DESCRIPTION OF THE FIGURES

FIG. 1 is a schematic block diagram of the computer system, databases, server, internet, foundation or other entity and the website accessible by the users and the hospital in one embodiment of the present invention.

FIG. 2 is a table of the modules of the computer system in one embodiment of the present invention.

FIG. 3 is a schematic block diagram of the donation module of the computer system in one embodiment of the present invention.

FIG. 4 is a schematic block diagram of the output control module of the computer system in one embodiment of the present invention.

FIG. 5 is a table of an example input pattern set and associated example user output set of the output control module in one embodiment of the present invention.

FIG. 6 is a front elevation perspective view of an internet access device and a schematic block diagram illustrating the function of the output control module in one embodiment of the present invention.

FIG. 7 is a schematic block diagram of the communication module of the computer system in one embodiment of the present invention.

FIG. 8 is a schematic block diagram of the user-to-user function of the communication module in one embodiment of the present invention.

FIG. 9 is a schematic block diagram of the user-to-hospital function of the communication module in one embodiment of the present invention.

FIGS. 9A to 9F are top plan views of example webpages of the communication module of the computer system in one embodiment of the present invention.

FIG. 10 is a schematic block diagram of the hospital-to-user function of the communication module in one embodiment of the present invention.

FIG. 11 is a schematic block diagram of the implementer-to-user function of the communication module in one embodiment of the present invention.

FIG. 12 is a schematic block diagram of the configuration module of the computer system in one embodiment of the present invention.

FIG. 13 is a schematic block diagram of the inking module of the computer system in one embodiment of the present invention.

FIGS. 14 to 16 are top plan views of example webpages of the website of the present invention.

FIG. 17 is a top plan view of a graphical user prompt of the website in one embodiment of the present invention.

FIG. 18 is a top plan view of a webpage including a compliment form of the website in one embodiment of the present invention.

FIG. 19 is a top plan view of a compliment attachment or report of the website in one embodiment of the present invention.

FIG. 20 is a flow diagram of the donation process in one embodiment of the present invention.

FIGS. 20A-20F are top plan views of the webpages of the donation process illustrated in FIG. 20.

FIGS. 21 to 23 are diagramatic top plan views of websites illustrating one example of the portal embodiment of the present invention.

### DETAILED DESCRIPTION OF THE INVENTION

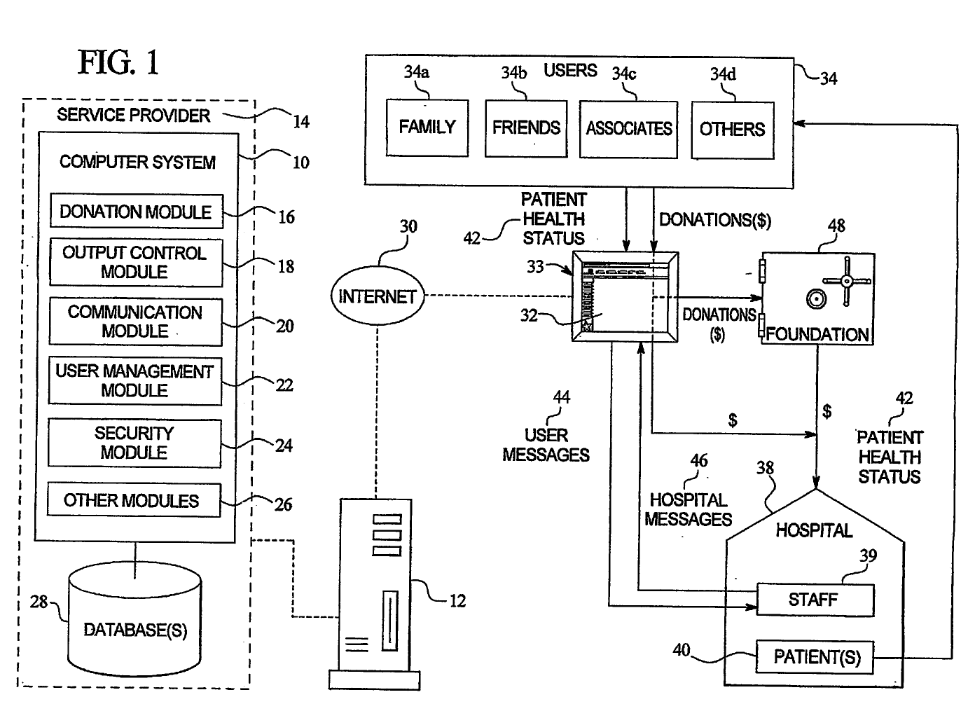

Referring now to the drawings, FIG. 1 illustrates one embodiment of the computer system 10 of the present invention. The computer system 10 includes a plurality of instructions which are readable by a processor or server. The instructions are preferably organized into a plurality of computer-readable modules 16 to 26. The one or more servers 12 use the computer system 10 to process information and store data in the one or more databases 28 as further described below. The computer system 10 can be stored on one or more memory devices, data storage devices or code storage mediums, including, without limitation, a disk, hard drive or computer chip.

The server 12 is connected to or otherwise in communication with a suitable electronic network including, but not limited, to a wide area network or a local area network. In the illustrated embodiment, the server 12 is connected to the Internet 30, and the server 12 is in communication with the computer system 10 as well as the database 28.

The computer system 10 directs the server 12 to present a graphical user interface to a plurality of end users 34. In the illustrated embodiment, the graphical user interface includes a plurality of webpages 32 of a website 33 hosted by the server 12. In addition to being accessible to users 34, the website 33 is also accessible to one or more organizations, such as a health care facility or hospital 38. The users 34 and hospital 38 can use any suitable internet access device to access the website 33, including but not limited to, client-sided personal computers, wireless personal digital assistants and wireless telephones.

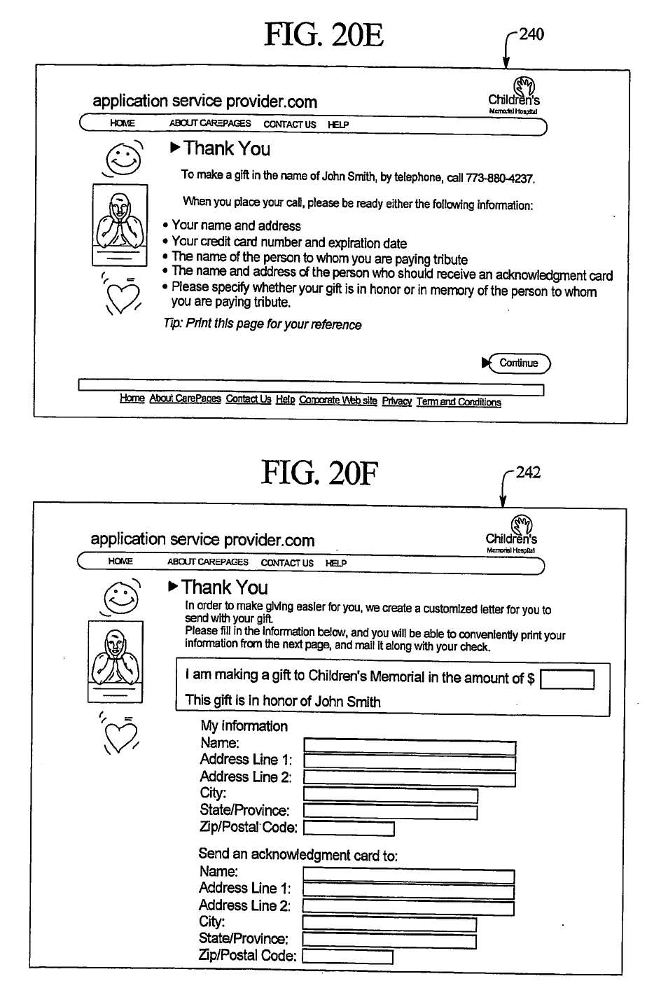

In the embodiments illustrated in FIGS. 1 to 22, the computer system 10 is used in a patient-hospital context. It should be appreciated, however, that the computer system 10 can be used in a variety of contexts. The website 33 can be accessible to any suitable business, association, institution, enterprise or organization which provides housing, room and board or support for residents or relocated persons. For example, the organization can include a health care provider or health care facility (including, without limitation, a hospital or long-term care facility), a health care institution, a hospice, a long term care institution, a nursing home, a home or household where health care services are received, a retirement home or facility for the elderly, a military unit, a college, a university, an education provider, a recreation provider, a camp, an apartment complex or a hotel used by an organization for special events.

In the patient-hospital embodiment, when a patient 40 is hospitalized, the patient 40 may not have the ability to communicate with family 34a, friends 34b, associates 34c and others 34d on a regular or unrestricted basis. This may be due to incapacity, illness, time schedule, lack of access to communication systems or other reasons. In order to stay up-to-date on the status of the patient 40, one or more of the users 34 may visit the patient 40.

In one example, while visiting the patient 40, a family member 34a may take pictures of the patient 40, talk to the physicians, nurses and staff and generally obtain information about the health condition of the patient 40. The computer system 10 enables this family member 34a to open a website account at the website 33 hosted by the server 12. After opening the website account, the family member 34a may invite other users 34 to become members of that website account.

The computer system 10 enables the family member 34a to upload a patient's health status 42 to the website 33 with the expectation that the family member 34a has the patient's or family's permission to do so. In this embodiment, the family member 34a, rather than the hospital 38, plays the role in releasing the patient's health information. Depending upon the applicable laws governing the operations of a particular hospital 38, the hospital 38 may be prohibited or restricted from disclosing medical information about the patient 40. The computer system 10 of the present invention enables such hospitals 38 to comply with such laws while enabling users 34 to access the patient's health status 42. This is because, in one embodiment, the hospital 38 does not release the patient's health status 42. Rather, the patient 38 voluntarily releases such information by authorizing one or more users 34 to post his/her health information on the website 33.

In addition to enabling the users 34 to stay up-to-date on the patient's health status, the computer system 10 also enables the family member 34a and other users 34 to send user messages 44 to one or more electronic addresses of the hospital 38. The staff 39 of the hospital 38 may then access and read those user messages 44. In addition, the computer system 10 enables certain staff members 39 to send electronic hospital messages 46 which are accessible to users 34 at the website 33.

Also, as further described below, the computer system 10 causes the website 33 to present charitable or financial contribution or donation information to the users 34. The donation information prompts the users 34 to make donations. The donation information also instructs the users 34 on how to make charitable or financial contributions or donations directly to the hospital 38 or to another entity 48, such as a nonprofit foundation, which is affiliated with the hospital 38.

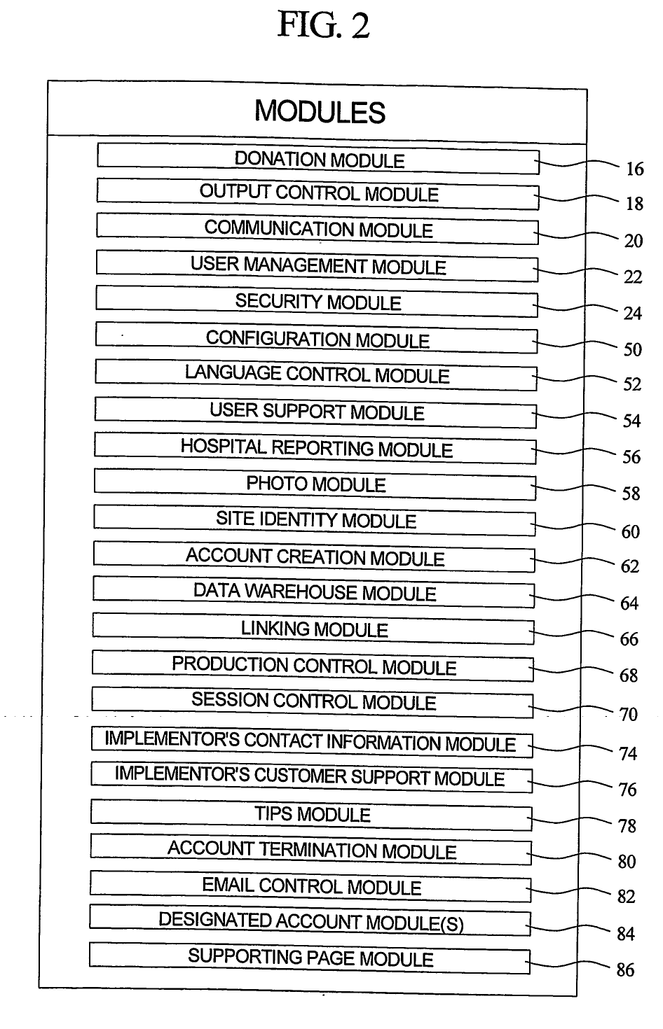

As described above, the computer system 10 includes a plurality of modules 16 to 26 which determine the overall functionality of the computer system 10. Each module includes a set of computer readable instructions which are related to a designated subject matter, topic or purpose. This type of modular construction of the computer system 10 can be written using any suitable computer programming language, including, without limitation, object-oriented languages such as commercially available JAVA and C++. In one embodiment illustrated in FIG. 2, the computer system 10 includes modules 16 to 24, 50 to 70 and 74 to 86. It should be appreciated, however, that the computer system 10 can be written as a single module or single set of instructions. In such case, the single set of instructions would have the functionality of the separate modules illustrated in FIG. 2.

### Donation Module

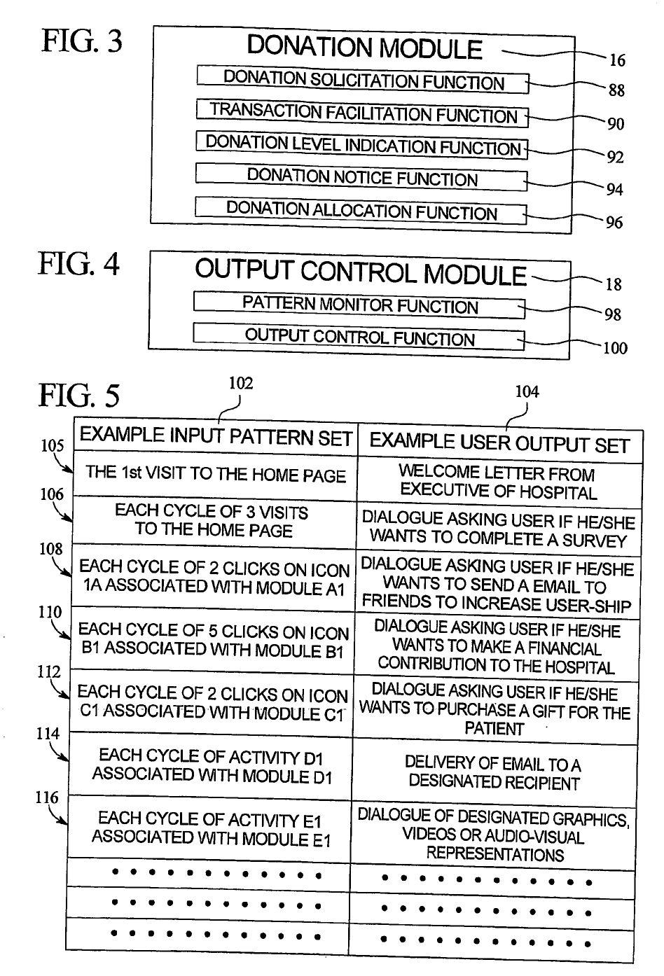

Referring to FIG. 3, in one embodiment, the donation module 16 includes a plurality of sub-modules or functions 88 to 96. Under the instructions of the donation solicitation function 88, the server 12 causes the website 33 to present donation information to the users. The donation information describes the donation process and, in particular, how to make donations to the hospital 38 or a foundation or other entity 48 associated with the hospital 38. The donation information can describe the need for donations and the benefits of donating.

In one embodiment, the donation solicitation function 38 causes a question or prompt to be presented to the users 34 at the website 33. The question may be, for example, “Would you like to learn more about how you can make a donation to the Atlanta Children's Hospital?” The donation solicitation function 88 may also cause the website 33 to present one or more links or inputs to the user to enable the user to access additional donation information or to begin the process of making a donation. As described below, the output control module 18 causes the donation prompts and donation information to be presented to the users 34 periodically based, in part, on the user's on-line activity history.

After the user accesses and views the donation information, the transaction facilitation function 90 causes the server 12 to present designated transaction information to the users 34 at the website 33. The transaction information describes different methods in which the users 34 can make a donation. In one embodiment, the transaction information includes information on how to make a donation to the hospital 38 or an entity 48 by phone, by non-electronic mail or electronically over the Internet 30. In one embodiment, the transaction facilitation function 90 presents one or more links or inputs to the users 34 at the website 33. Upon the a user's activation of one or more of these input, the server 12 reroutes the user to a website of the hospital 38 or other entity 48. This website then enables the rerouted user to make an online donation.

In another embodiment, the transaction facilitation function 90 includes one or more inputs which enable the users 34 to make donations electronically using the website 33. In this embodiment, the server 12 receives payment or donation information from the users 34 and transfers this information to the hospital 38 or entity 48 associated with the hospital 38. The online or electronic transactions can be implemented using any suitable technique, including without limitation, credit card payment, wire transfer or electronic find transfer.

Under direction of the donation level indication function 92, the server 12 causes the website 33 to display one or more indicators to the users 34. These indicators are preferably images which indicate to the users 34, a running donation total or level which the users 34 have collectively contributed at any one point in time. These indicators can have any suitable configuration, including, but not limited to, meters and dials.

As instructed by the donation notice function 94, the server 12 causes one or more notices to be delivered to the patient's family when a user 34 makes a donation. For example, if a user 34 donates five hundred dollars to the Atlanta Children's Hospital where the patient 40 is hospitalized, the donation notice function 94 may cause the website 33 to present an input to the user 34. The input may provide the user 34 with the opportunity to send a notice to the patient by activating the input. Upon activation, the server 12 sends the notice to the patient's family. The notice can include only the identity of the donator and the fact that this donator made a donation. Alternatively, the notice can include additional information such as the amount of the donation or a message from the donator. In one embodiment, this notice is an electronic notice delivered from the server 12 to an electronic address of the patient or the patient's family. In another embodiment, the notice is a card or other document delivered through non-electronic mail to the hospital or the patient's family. In addition, the donation notice function 94 can include a plurality of instructions which direct the server 12 to present one or more delivery options or delivery inputs at the website 33. The delivery inputs, when activated by the users 34, cause cards, balloons, gifts or other items to be delivered to the patient or the patient's family when the users 34 make donations.

Under instruction of the donation allocation function 96, the server 12 causes the website 33 to present at least one allocation input to the users 34 at the website 33. When a user 34 activates the allocation input, the user 34 can allocate different portions of his/her donation to different people or entities. For example, if the user 34 makes a donation of five hundred dollars, the donation allocation function 96 enables the user 34 to allocate four hundred dollars to the hospital 38 and one hundred dollars to the patient or the patient's family.

### Output Control Module

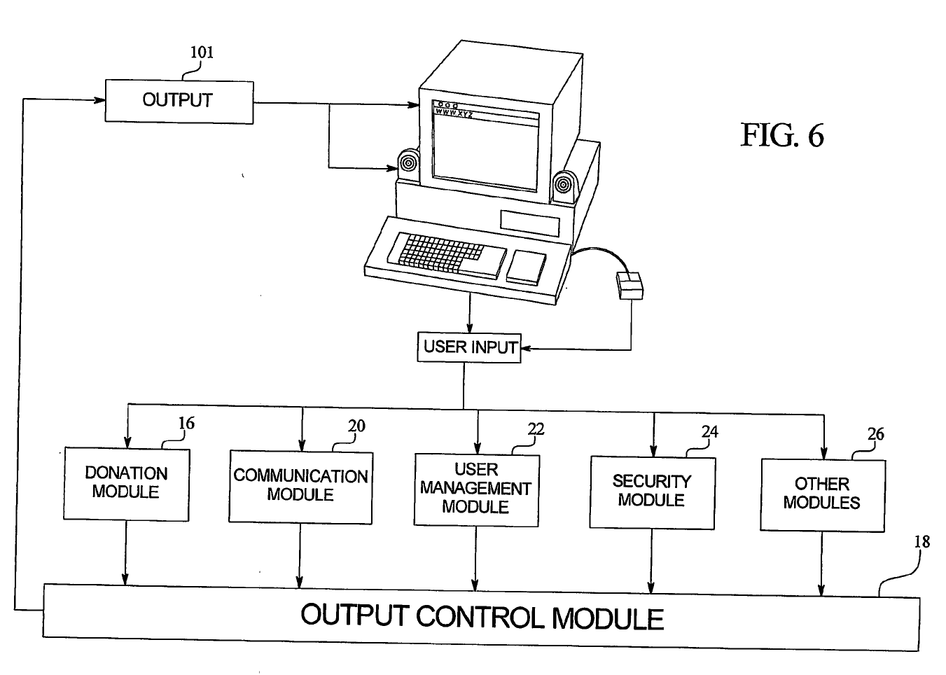

As best illustrated in FIGS. 4 to 6, the output control module 18 includes a pattern monitor function 98 which enables the server 12 to monitor the historical pattern of inputs made by the users 34. The output control module 18 also includes an output control function 100 which the server 12 uses to produce the outputs 101 to the users 34. Functionally, the output control module 18 correlates or associates a set of user input patterns with a set of outputs to users. The output control module 18 causes the server 12 to provide certain outputs when the server 12 detects certain input patterns.

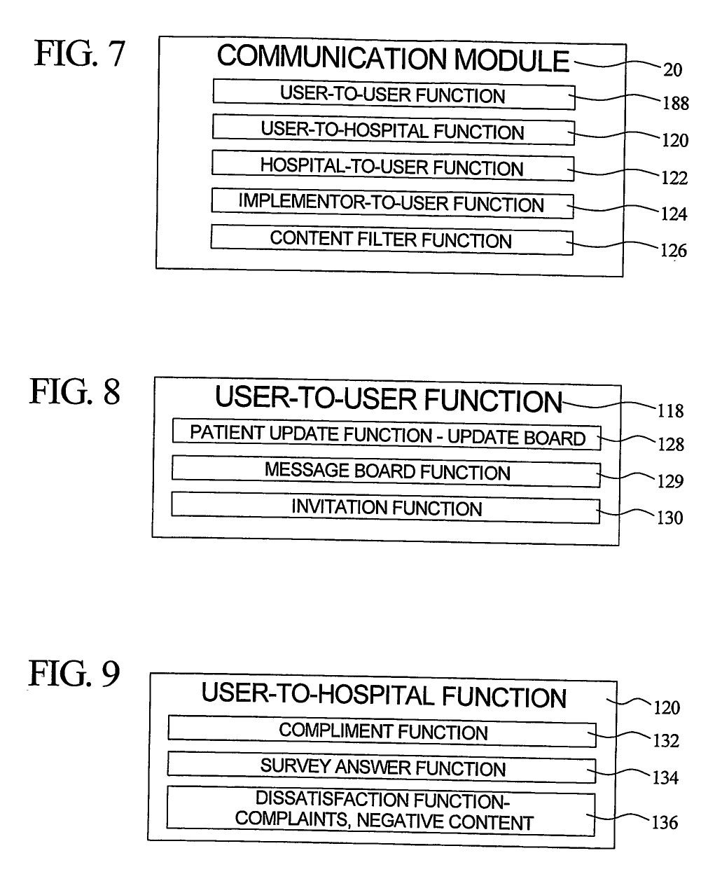

In one example illustrated in FIG. 5, the output control module 18 includes a input pattern set 102 associated with an output set 104. As illustrated in row 105, when a user 34 makes an initial visit to a home page of the website 33, the control module 18 directs the server 12 to cause the website 33 to display a welcome letter from an executive of the hospital 38. As illustrated in row 106, every time a user 34 completes a cycle of three visits to the home page, the control module 18 directs the server 12 to cause the website 33 to present designated dialogue to the user. For example, the dialogue may ask the user if he/she wants to complete a survey of the hospital 38. As illustrated in row 108, every time a user 34 completes a cycle of two clicks on a designated icon A1 associated with a designated module A1 of the system, the server 12 causes the website 33 to present dialogue to the user, asking the user if he/she wants to send an email to a friend to increase user-ship of the website 33. As illustrated in row 110, every time a user 34 completes a cycle of five clicks on a designated icon B1 associated with a designated module B1 of the system, the server 12 causes the website 33 to present dialogue to the user, asking the user if he/she wants to make a financial contribution or donation to the hospital. As illustrated in row 112, each time a user 34 completes a cycle of two clicks on a designated icon C1 associated with a designated module C1, the server 12 causes the website 33 to present dialogue to the user, asking the user if he/she wants to purchase a gift, such as a card or balloons for the patient. As illustrated in row 114, each time a user 34 completes a cycle of a designated activity D1 associated with a designated module D1, the server 12 delivers a designated email to a designated recipient. As illustrated in row 116, each time a user completes a cycle of a designated activity E1 associated with a designated module E1, the server 12 causes the website 33 to display or output designated graphics, videos, sound recordings or audiovisual representations to the user.

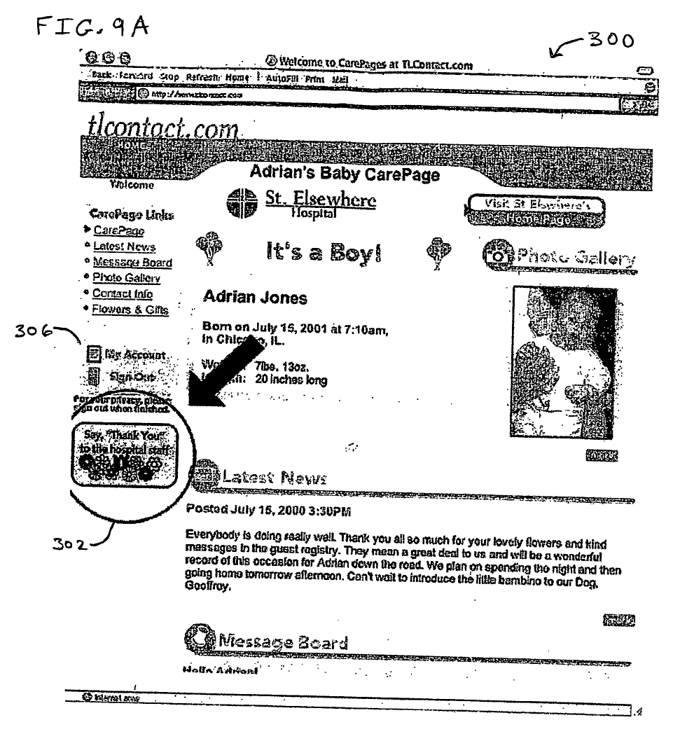

As best illustrated in FIG. 6, the output control module 18 is operatively coupled to the modules 16 to 26. The modules 16 to 26 determine what outputs 101 are available for the users 34, and the output control module 18 determines the timing of these outputs 101. In one embodiment, the output control module 18 includes a behavioral or psychological characteristic associated with the input pattern set 102 and user output set 104. This behavioral characteristic preferably has a psychological impact on certain decisions made by the users 34. For example, depending upon when a user 34 is presented with an opportunity to make a donation, a user 34 may or may not decide to make that donation. By controlling the time scheme of prompts and outputs to the users 34, the output control module 18, in one embodiment, has a psychological effect which encourages the users 34 to provide information and/or donations to the hospital 38.

### Communication Module

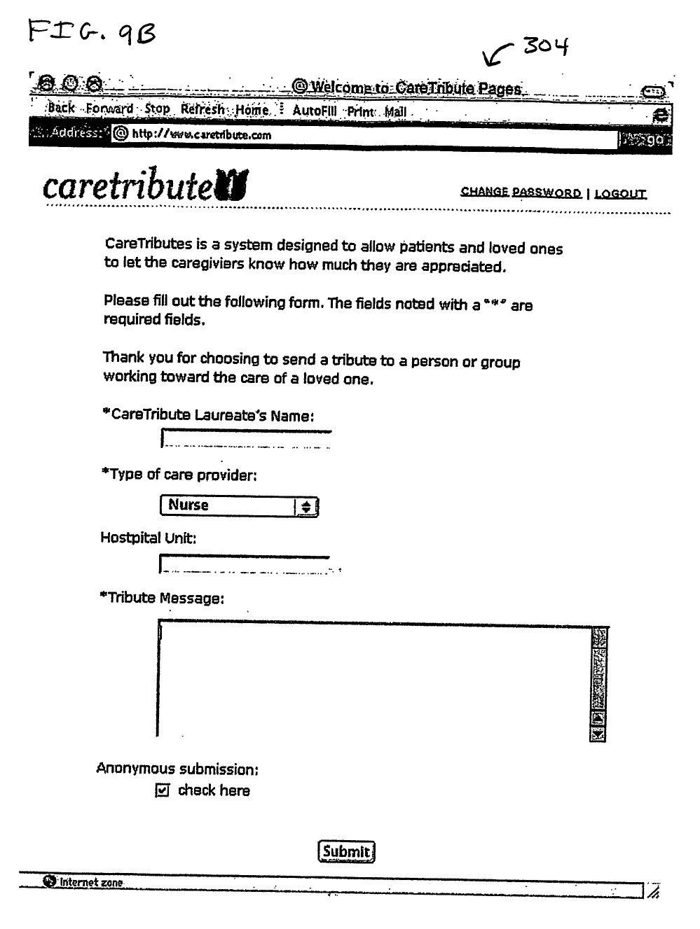

Referring to FIG. 7, the communication module 20 of the computer system 10, in one embodiment, includes: (a) a user-to-user function 118 which involves communications between users 34; (b) a user-to-hospital function 120 which involves communication from users 34 to the hospital 38; (c) a hospital-to-user function 122 which involves communications from the hospital 38 to the users 34; (d) an implementer-to-user function which involves communications from an application service provider or other implementer 14 of the system 10 to the users 34; and (e) a content filter function 126 which screens communications for designated subject matter or content.

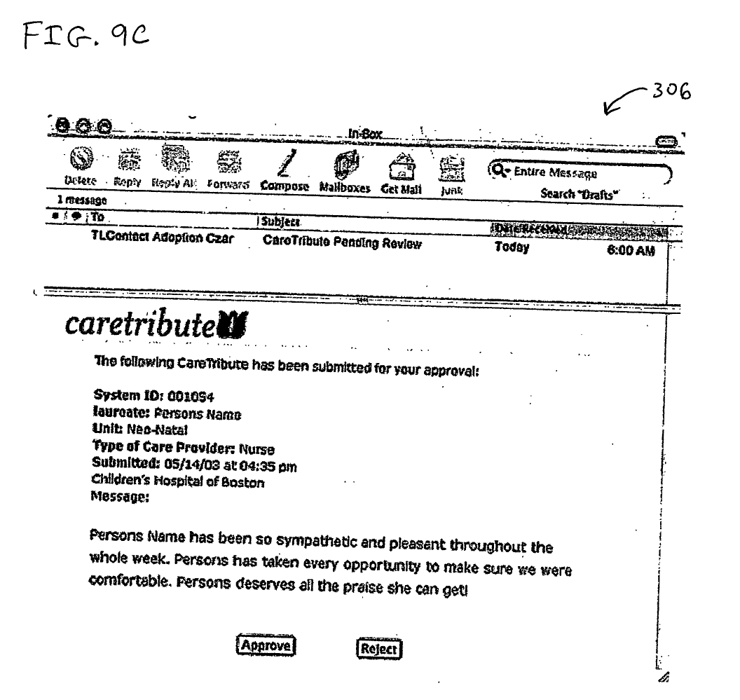

As further illustrated in FIG. 8, in one embodiment, the user-to-user function 118 includes a patient update function 128, a message board function 129 and an invitation function 130. The patient update function 128 includes a plurality of instructions which direct the server 12 to enable one or more of the users 34 to display information at the website 33 pertaining to the status of the patient 40. In one embodiment, the user 34 who opened the website account is designated as an administrator or manager as further described below. The computer system 10 enables this user, and no other user, to post updates about the patient on the website 33. The other users can access and view these updates by accessing the website 33. Accordingly, the patient update function 128 enables the administrator or manager of the website account to communicate information about the patient to the other users.

From time to time, certain users 34 may wish to post messages to other users 34 regarding the patient 40. The message board function 129 facilitates this process. The message board function 129 includes a plurality of instructions which direct the server 12 to enable the users to post information on a message board displayed at the website 33. The message board can be any area or space on the website 33 designated for such purpose. For example, a user 34 may post a message on the message boards stating “Susan is a tough cookie. I'm happy to hear things are going so well, and I look forward to playing volleyball with Susan at the family reunion this summer.”

The invitation function 130 enables each of the users 34 to invite non-users to join or become members of the website account. In one embodiment, the invitation function 130 includes a plurality of functions which direct the server 12 to cause the website 33 to display one or more links or inputs to the users 34. For example, the website 33 may display an icon or text to a user 34 indicating that if the user 34 clicks on that text, the user 34 will be able to invite non-users to join the account. In such embodiment, when the user 34 makes this input, the invitation function 122 enables the user 34 to send one or more emails to one or more non-users. Preferably, the email includes a designated description of the website service provided by the implementer 14 of the system 10. Accordingly, the invitation function 122 serves a role in soliciting use of the website 33 by others.

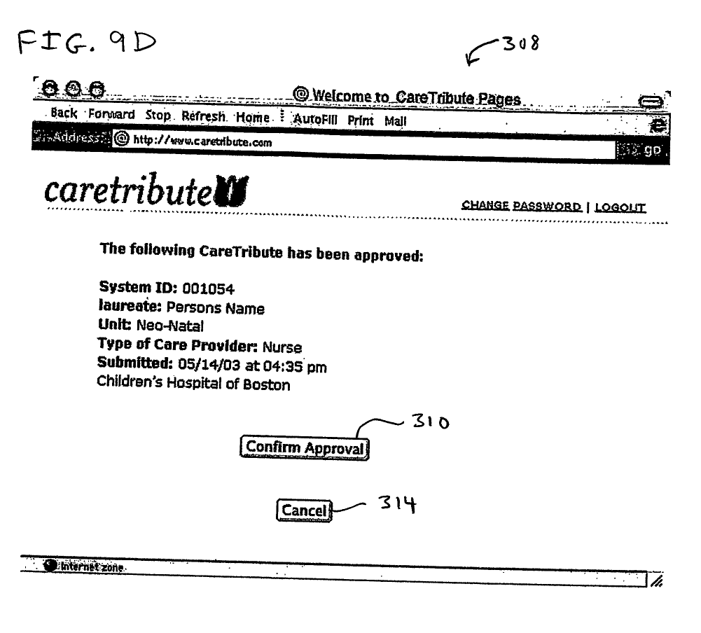

Referring to FIG. 9, the user-to-hospital function 120, in one embodiment, includes a compliment function 132, an answer survey function 134 and a dissatisfaction function 136. The compliment function 132 includes a plurality of instructions which direct the server 12 to enable the users 34 to electronically send compliments to staff members of the hospital. The compliment function 132 causes the website 33 to display designated text or questions, prompting or otherwise asking the users 34 if they are interested in making a compliment. If a user 34 is so interested, the user 34 makes an input at the website 33, and the compliment function 132 provides the user 34 with a form or designated space on the website 33 to write a message. After completing the message, the compliment function 132 enables the user 34 to electronically send that message to a designated email address of the hospital 38. In one embodiment, the message includes a compliment certificate. When a designated administrator of the hospital 38 opens the email, the administrator can print the certificate and present the certificate to the staff member who received the compliment. This can help increase staff morale and strengthen the patient-staff relationship.

In one embodiment illustrated in FIGS. 9A-9F, the compliment function 132 includes a CareCompliment™ system or compliment system that facilitates a feedback loop by directing screened messages of tribute and thanks, from users or members to a health care professional honoree and the key hospital administrator, such as the head of nursing and the head of human resources, respectively. This system can be used to honor an outstanding nurse or other hospital staff members.

This compliment system performs one or more of the following functions: (a) soliciting compliments from members; (b) capturing compliment messages for later screening and delivery to the health care facility; (c) review and approval of the delivery of compliment messages to the health care facility; (d) emailing the compliment message to the designated honoree when the address is known; (e) when such address is unknown, emailing the compliment message to pre-selected hospital designees whose email addresses have been pre-configured in the system; (f) providing a webpage listing of all compliment messages which have been created for the health care facility; and (g) providing mechanisms that aid in the capture and validation of the names and email address of honorees.

As illustrated in the example webpage 300 shown in FIG. 9A, this compliment system includes an appeal or solicitation function that encourages users to provide compliments. At times determined by the output control module 18, the webpage 300 presents a graphically distinguished static link 302 to promote compliment awareness and action. Upon a user's activation of link 302, the compliment system causes the website 300 to present a compliment submission dialog or form 304 to the user. In one embodiment, the link 302 appears once per member and only to managers or co-managers.

In one embodiment, the graphical link 302 is located on the left rail below the ‘my account’ box 306 of the webpage 300. The link 302 will forward the user to the submission dialog 304 described below. The graphic, in one embodiment, is the width of the boxes above it and of a height so as to be conspicuous. The graphic may include a suitable animation.

The submission dialog or submission form 304, illustrated in FIG. 9B, includes an inline dialog used to collect compliments from members or users. The form 304 provides the user with a description of the compliment process and instructions for completing the compliment form 304. The form 304 also communicates how submissions will be used and reviewed. In one embodiment, when this dialog is launch from the link 302, the form 304 appears inline with the parent window and not inline with the pop-up window. After the form 304 is submitted, in one embodiment, the user will be forwarded to a confirmation page with a continue button that returns the user to the page they were previously viewing.

In one embodiment, the submission form 304 includes a plurality of fields to collect the information indicated in the following Table I:

TABLE I

| Field Name | Form Field Type | Notes |
|---|---|---|
| Honoree's first and last | Text boxes for each | Validation rule: Require |
| name | | first and last names OR |
| | | Hospital Unit OR both |
| | | name and unit. |
| Honoree's email | Text box | Form validation will |
| | | include basic email |
| | | address validation. |
| | | Nurses may distribute |
| | | business cards |
| | | introducing the service |
| | | of the present invention. |
| | | The cards will include |
| | | the nurse's name and |
| | | email. |
| Type of health care | Dropdown | Nurse, Doctor, Physical |
| provider | | Therapist or Other |
| Hospital Unit | Text box | Open text box. See |
| | | validation rule for |
| | | honorees name. |
| Tribute message | Text Area - 4000 | Error indication on |
| | characters | overflow. |
| Anonymous | Checkbox | Any suitable notes. |
| submission | | |

The compliment system, in one embodiment, enables users to anonymously make compliment submissions. This may be suitable for users who feel uncomfortable revealing their identity or who wish to not have their names used on a public listing.

In addition, the compliment system includes a compliment message review and approval function or tool. This tool presents a webpage 306 to the users. Webpage 306 includes a plurality of inputs or links which enable the user to edit the content of his/her compliment message. In the webpage 306, the tool sends an email to the user, stating the following: (a) compliment system id; (b) honoree's name (may be a person's name or a group title); (c) hospital unit; (d) type of health care provider; (e) submission date and time; (f) facility name; and (g) tribute message.

The email also includes two buttons—one to approve and one to reject the compliment or tribute. When clicked on, these buttons launch a browser window that displays a login box. A special login is assigned to each account representative for the screening of the compliment messages. After successful login, the compliment system displays a webpage 308 indicating the system identification and prompting the user for action confirmation. In one embodiment, the format, color and text on this webpage 308 provides an indicator of the action being taken.

Upon the user's activation or click of the approval button 310, the compliment system completes the action and delivers a transaction confirmation page to the user. If, on the other hand, the user clicks on the reject button 314, the compliment system cancels the transaction and leaves the compliment record unchanged. In one embodiment, in each case, the confirmation page 308 includes the account management links enabling the user to change the password and to logout.

The system enables the screener who is implementing the present invention to avoid logging in repeatedly by leaving the original browser open. Subsequent clicks of the approve/reject buttons in other emails will make use of the session established by the original window. In one embodiment, to manage erroneous double processing due to inadvertent multiple clicks, the system detects and alerts the user when a record has already been processed.

If the record is rejected, the tribute is excluded from further processing. If the record is approved, the system records its new status. If the implementer of the present invention determines that a rejected tribute indicates a problem with hospital staff, the implementer may choose to send the author a response indicating the appropriate hospital contact for the problem.

In one embodiment, the compliment system makes use of email as the interface for account managers to screen compliment messages. This design has the following advantages, among others: (a) email serves as a relatively convenient prompt or reminder; (b) review and decision-making can be done while offline (on a plane, for example) by sorting approved and rejected messages to separate folders; (c) once sorted, compliment records can be relatively quickly updated by clicking on the appropriate links in the emails; and (d) having an electronic copy of submissions is relatively convenient, especially where an account manager wishes to follow up with an account contact about commentary made in a tribute.

In one embodiment, the compliment system delivers the compliment messages to honorees using email. If the compliment system does not have the honoree's email address, then pre-selected hospital designees whose email addresses have been configured in the system receives the email. Once approved, compliment messages are packaged and emailed to department heads and administrators specified by the health care facility. In one embodiment, the system enables up to two thousand characters for executive email addresses (approximately seventy-five to one hundred addresses). These addresses are stored in the system database 28 and are used specifically by the compliment system.

If there are new compliment messages, the compliment system automatically formats and sends a single multipart (HTML/text) email 316 per health care facility per day. In one embodiment, the time of delivery is common to all health care facilities. The multipart email message 316 is rendered in HTML in a compatible email client. If the email client does not support HTML, the email client displays the text-only version of the message. The message 316 will include: (a) brief text describing the compliment program or process; (b) honoree's name; (c) tribute date of submission; (d) tribute text; (e) name of tribute submitter if not anonymous; (f) for compliments with a non-validated honoree name and address, a link to the compliment system forward function described below; and (g) a link to the health care facility's compliment listing described below.

If the compliment system has the honoree's email address, the compliment system automatically formats and sends one multipart (HTML/text) email directly to the honoree. In one embodiment, the time of delivery is common to all hospitals. The multipart email message is be rendered in HTML in a compatible email client. If the email client does not support HTML, the email client displays the text-only version of the message. The message includes: (a) brief text describing the compliment process or program; (b) tribute date of submission; (c) tribute text; (d) name of tribute submitter if not anonymous; (e) for compliments with a non-validated honoree name and address, a link to the compliment system forward function described below; and (f) a link to the health care facility's compliment listing described below.

Referring to FIG. 9F, the compliment system includes a webpage 318 that presents a compliment listing 320 in a tabular format. The webpage 318 appears in a co-branded color scheme and is sorted by submission date in descending order. The webpage 318 provide links to the home pages of the website 33 and the website of the implementer of the present invention.

In one embodiment, the listing 320 includes an entry that contains the following information: (a) honoree's first name and initial of last name; (b) hospital unit; (c) type of health care professional; (d) tribute date of submission; (e) name of tribute submitter if not anonymous; (f) tribute text; and (g) a link to a printable compliment certificate. The compliment certificate is a printable certificate that can be used as a keepsake. The compliment system includes a link to the certificate in the listing 320 and in the compliment email message 316.

In addition, the compliment system includes a compliment forwarding function. This function is suitable in the situation where the executive summary email 318 has multiple compliments for different honorees. The compliment forwarding function enables the hospital's management designees to forward a single compliment message listed in the email 318 to the appropriate honoree in a relatively simple and convenient fashion. The forwarding function presents the user with a forwarding link for each compliment in the email 318. Upon the user's activation or clicking of this forwarding link, the link launches a form in a new browser window. The form includes a plurality of inputs for: (a) the honoree's email address (with email validation); (b) an editable, pre-populated text box with the honoree's name; (c) an editable, pre-populated text box with the honoree's unit; and (d) a text area for comments. When the user submits the form, a compliment email with the comments from the sender is formatted and sent to the appropriate honoree. In addition, the compliment system stores the honoree's name and email address, and the system adds the honoree's name to an honoree dropdown in the compliment submission form.

Referring back to FIG. 9, the user-to-hospital function 120 also includes a survey answer function 134. The survey answer function 134 includes a plurality of instructions which direct the server 12 to process the users' answers to the surveys of the hospital. As further described below, the computer system 10 periodically presents surveys from the hospital 38 to the users 34. When the users 34 complete the surveys and activate an input at the website 33, the survey answer function 134 directs the server 12 to transmit the answers or completed surveys to a designate email address of the hospital 38.

The dissatisfaction function 136 of the user-to-hospital function 120 includes a plurality of instructions which direct the server 12 to enable users to electronically provide constructive criticism or even negative comments to the hospital 38. Here, the dissatisfaction function 136 causes the server 12 to present one or more inputs at the website 33. The inputs enable the users 34 to electronically send messages directly to the hospital 38. In one embodiment, these messages, which may or may not be screened, are sent to a designated email address of the hospital 38. This email address may be accessible to a select number of hospital staff members such as select administrators, public relation officers or legal counsel. If, for example, users 34 are concerned that the hospital 38 is engaged in malpractice or mistreatment of the patient 40, the dissatisfaction function 136 enables the users 34 to vent their concerns and frustration. At the same time, the hospital 38 can contact these users 34 in an attempt to improve health care services to the patient 40 and also in an attempt to resolve disputes without lawsuits and negative publicity.

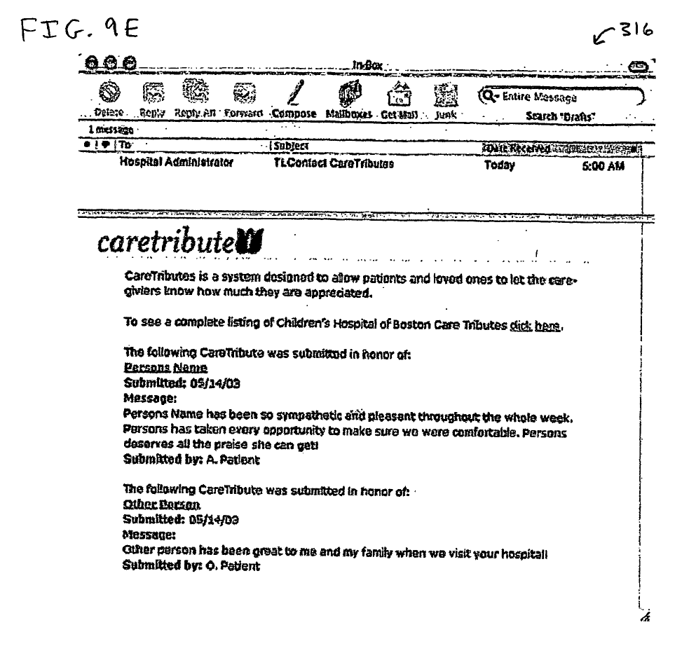

As illustrated in FIG. 10, the hospital-to-user function 122 of the communication module 20 enables the hospital 38 to electronically send information and messages to the users 34. In one embodiment, the hospital-to-user function 122 includes a form correspondence function 138, a survey function 140 and a user inbox function 142. The form correspondence function 138 includes a plurality of instructions which direct the server 12 to cause the website 33 to present one or more designated forms, documents or letters from the hospital 38 to the users 34. In one embodiment, the form correspondence function 138 directs the server 12 to send a form welcome letter to the users 34. The form welcome letter includes a welcome message from a high ranking officer in the hospital 38. In one embodiment, the form correspondence function 138 causes the server 12 to present such a welcome letter to the users 34 upon their initial visit to the website 33.

The survey function 140 of the hospital-to-user function 122 includes a plurality of instructions which direct the server 12 to present surveys from the hospital at the website 33 when designated events occur. These surveys include questions or prompts which elicit information from the users 34. The information may relate to feedback on the hospital's quality of health care services, the experiences of the users 34 with the hospital 38 or any suggestions for improvements in the hospital's health care services. After completing the survey, the survey function 140 causes one or more inputs to be presented to the users 34 at the website 33. When the users 34 activate these inputs, the completed surveys are electronically delivered to a designated email address of the hospital 38.

It should be understood that the welcome letters and surveys, in addition to other outputs of the system 10, are displayed to the users 34 at times determined by the output control module 18 described above. For example, after every tenth visit to the website 33 by a user 34, the computer system 10 may present a question asking the user 34 if he/she is interested in completing a survey or making a donation.

The user inbox function 142 of the hospital-to-user function 122 includes a plurality of instructions which direct the server 12 to cause the website 33 to display one or more inputs to the users 34. When the users 34 activate these inputs, the website 33 enables the users 34 to access electronic mail delivered by the hospital 38. The electronic mail may relate to any suitable topic, such as upcoming improvements in the hospital's facilities, publicly available medical information, advancements in medical technology or helpful support services or resources.

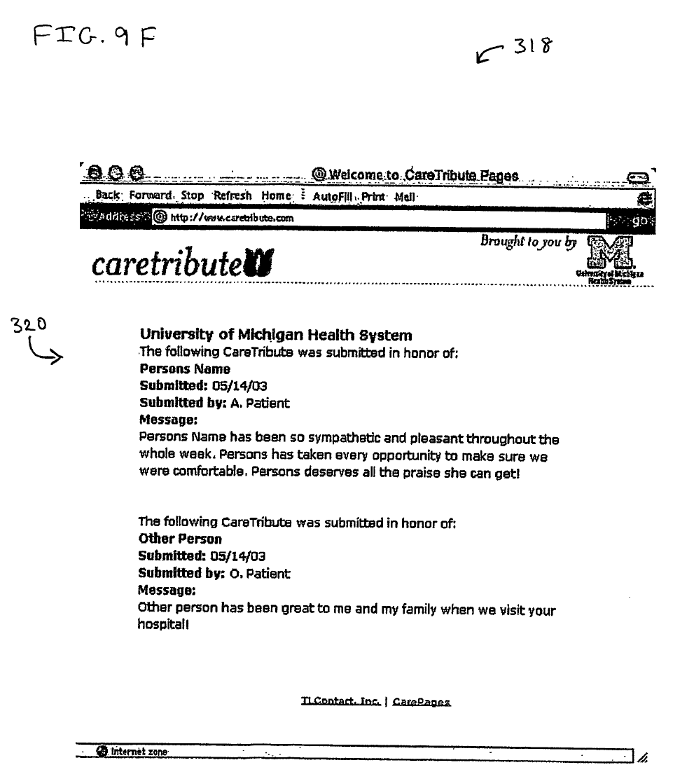

As illustrated in FIG. 11, the implementer-to-user function 124 of the communication module 20 includes a user promotion function 144. The user promotion function 144 includes a plurality of instructions which direct the server 12 to cause certain messages to be displayed to the users 34 at the website 33. These messages encourage the users 34 to promote the use of the website 33 to non-users. These messages, which are provided by the application service provider or implementer 14 of the website 33, can also describe the benefits of the website 33. The implementer-to-user function 124 can also include a plurality of instructions which direct the server 12 to display various messages to the users 34, such as messages about upcoming features of the website 33, online security issues or other matters.

### Other Modules

Referring back to FIG. 2, the computer system 10 also includes modules 22 to 70 and 74 to 86 which will now be described in further detail. The user management module 22 includes a plurality of instructions which direct the server 12 to enable one or more designated users 34 to control and restrict access to the website 33. In one embodiment, the user management module 22 enables one user to be designated as the website account administrator or manager. This manager serves the role as the gatekeeper to the website account. Before any other user 34 can join the website account, the manager must first approve that user. The user management module 22 enables the manager to make one or more inputs at the website 33 to permit other users to join the website account or to deny such users from joining the website account.

The security module 24 includes a plurality of instructions associated with the purpose of securing the information which the users 34 provide or otherwise view at the website 33. The security module 24 includes a plurality of protocols adapted to encrypt data or otherwise render data inaccessible to the public. In one embodiment, the security module 24 includes a commercially available protocol known as Secure Sockets Layer (SSL). The security module 24 can also include a commercially available protocol known as Secure HTTP (S-HTTP) adapted to transmit individual messages securely.

In one embodiment, the security module 24 directs the server 12 to activate the security protocols for a secure session when the users 34 make designated inputs at the website 33. For example, when a user 34 makes an input to access a particular webpage 32 or to review a patient update 42, the security module 24 can cause the server 12 to activate a secure session guarded by SSL or another suitable security protocol. In another embodiment, the security module 24 can direct the server 12 to apply security protocols to all information provided by users and presented to users at the website 33, as well as all transactions conducted by users at the website 33.

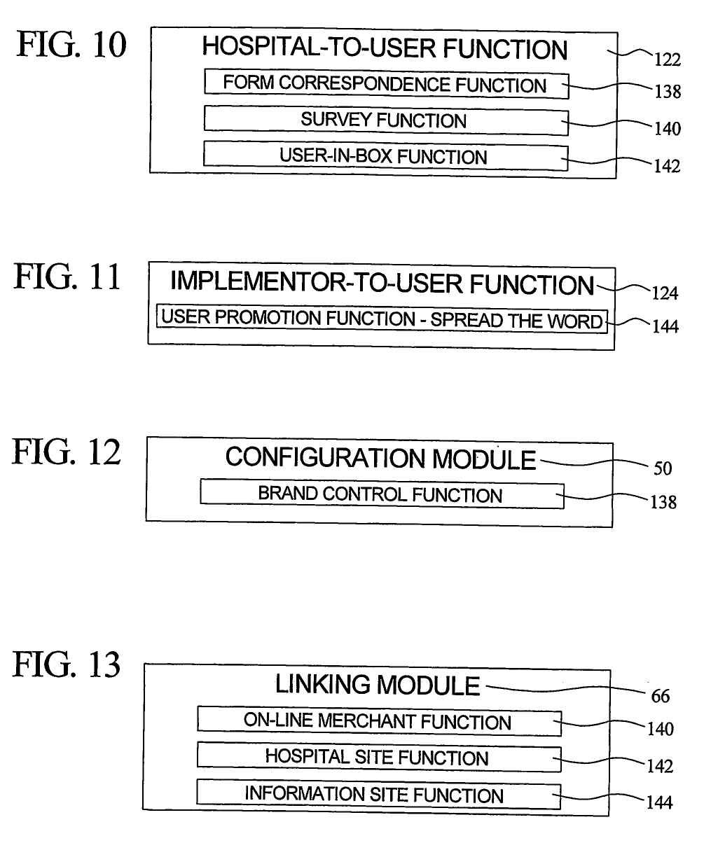

As best illustrated in FIG. 12, the configuration module 50 includes a brand control function 138. Generally, the configuration module 50 includes a plurality of instructions which enable the hospital 38 to adjust designated settings which effect how the computer system 10 and website 33 operate. In one embodiment, the configuration module 50 enables the hospital 38 to select variable input patterns for the output control module 18. For example, the configuration module 50 may enable the hospital 38 to determine whether a survey opportunity is presented to the user each time the user posts a message on the message board or every fifth time a user reviews a patient update.

In one embodiment, the configuration module 50 includes a brand control function 138. The brand control function 138 includes a plurality of instructions which direct the server 12 to cause the website 33 to have a particular graphical appearance. In this embodiment, the brand control function 138 includes a plurality of protocols which enable the hospital 38 to select a plurality of parameters such as hospital name, color scheme, hospital logo, audio effects or other graphical representations. For those hospitals that have their own publicly available websites, the brand control function 138 enables these hospitals to cause the website 33 to have an overall appearance or look which is the same as, similar to or substantially similar to the hospital's website. For example, if the hospital's website includes a blue and burgundy colored border, the brand control function 138 enables the hospital to configure the website 33 so that the website 33 has a blue and burgundy colored border. Therefore, the brand control function 138 enables the website 33 to have an overall look and feel which is similar or substantially similar to the look and feel of the hospital's own website or marketing materials. The users 34 are more likely to be under the impression that the website 33 is actually a website of the hospital. This provides the hospitals with an additional on-line forum for the advertisement, promotion and branding of their goods and services.

Referring back to FIG. 2, the language control module 52 includes a plurality of instructions which enable the server 12 to present the text at the website 33 in a plurality of different human readable languages, including, but not limited to, English and Spanish. In one embodiment, the language control module 52 includes a set of translation protocols, and the language central module 52 causes the server 12 to present one or more inputs to a user 34 at the website 33. Upon the user's activation of that input, the server 12 causes the text on the website 33 to appear in a language selected by the user.

The user support module 54 illustrated in FIG. 2 includes a plurality of instructions associated with providing assistance to users in operating the website 33. In one embodiment, the user support module 54 causes the server 12 to present one or more inputs to the user 34. Upon the user's activation of these inputs, the website 33 provides the user 34 with access to an online help system. The help system preferably includes information helpful to the users in operating the website 33. In one embodiment, the online help system includes a key word search function which assists the users 34 in finding answers to their questions.

The hospital reporting module 56 includes a plurality of instructions associated with the reporting of information to the hospital 38 by the implementer 14 of the computer system 10. In one embodiment, this information is related to the expenses associated with operating the website 33 and other website operational information. The hospital reporting module 56 enables application service providers or implementers 14 of the computer system 10 to report this information to the hospitals 38 on a periodic basis. This reporting can occur electronically or non-electronically. In those cases where the hospitals have chosen to find the operation of the website 33, this reporting assists the hospitals in providing an appropriate amount of finding and budgeting for the website 33.

With continued reference to FIG. 2, the photo module 58 includes a plurality of instructions associated with visual, audio and/or audiovisual representations of the patient 40. In one embodiment, the photo module 58 directs the server 12 to provide one or more inputs to the users 34 at the website 33. Upon activation of these inputs, the server 12 enables the users to view audio, visual and/or audiovisual representations of the patient 40. Also, the photo module 58 causes the server 12 to present one or more inputs to the manager of the website account. Upon the manager's activation of these inputs, the server 12 enables the manager to upload or otherwise post photographs, sound files and/or videos at a designated area on the website 33. For example, the photo module 58 may enable users 34 to access a photo gallery at the website 33 and view recent photographs of the patient 40 at the gallery.

The site identity module 60 illustrated in FIG. 2 includes a plurality of instructions associated with designated graphics, images and text which are displayed on all or substantially all of the webpages 32 of the website 33. For example, the site identity module 60, in one embodiment, directs the server 12 to cause each webpage 32 to display a designated menu of links as well as an area where the users 34 can log-in and log-out of a session at the website 33. The site identity module 60 therefore provides a template shared in common by all or substantially all of the webpages 32. The implementer 14 of the computer system 10 can therefore change this template for all such webpages 32 with relatively high efficiency.

The account creation module 62 includes a plurality of instructions associated with creating a website account for the website 33. These instructions enable a user 34 to designate himself or herself as the manager and to open a website account. In one embodiment, account creation module 62 directs the server 12 to provide a plurality of inputs at the website 33. Upon a user's activation of these inputs, the account creation module 62 causes the server 12 to establish a website account for the manager.

In one embodiment, the server 12 hosts a single website 33 which is associated with a plurality of different website accounts for a plurality of different groups of users 34. Each website account is associated with a different set of webpages 32 for private use by the different user groups. This embodiment is suitable for users who seek to establish webpages 32 when there has not yet been a website 33 established for the hospital. In this embodiment, the website 33 may not have the look and feel of a hospital's website. Rather, the website 33 may have a designated graphical appearance. This appearance may make it apparent to the users that the website 33 is operated by a service provider distinct from the hospital 38.

In another embodiment, the server 12 hosts a plurality of different websites 33 which have been established for different hospitals. Each of the websites 33 is associated with a different website account for a different group of users 34. Each website account is associated with a different set of webpages 32 for private use by the different user groups.

Referring again to FIG. 2, the data warehouse module 64 includes a plurality of instructions associated with the transfer of data to and from the one or more databases 28. In one embodiment, the data warehouse module 64 operatively couples the computer system 10 to the databases 28. In this role, the data warehouse module 64 functions as a data interface which enables the server 12 to use the computer system 10 to exchange data with the databases 28.

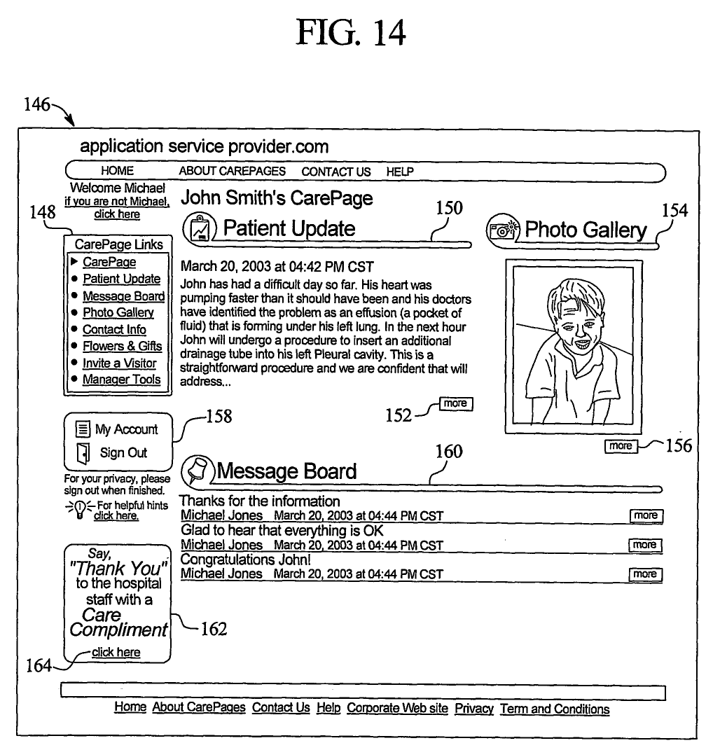

As best illustrated in FIG. 13, the linking module 66 includes an online merchant function 140, a hospital site function 142 and an information site function 144. Each of these functions include a plurality of instructions which are associated with enabling the users 34 to electronically access one or more resources from the website 33. In one embodiment, the online merchant function 140 causes the server 12 to present one or more inputs, such hyperlinks, at the website 33. Upon a user's activation of these inputs, the server 12 transfers the user to an e-commerce enabled website where the user can purchase goods or services. For example, the hospital 38 may operate an e-commerce website for a gift shop located in the hospital 38. The users would be able to access this website by activating a link at the website 33. At that point, the users could use the gift shop website to order balloons or other items to be delivered to the patient 40. Alternatively, the merchants can be third parties not associated with the hospital 38. For example, the merchant could be any suitable online bookstore, online gift shop or online food store. In using these online stores, the users can order goods to be delivered to the patient 38 or to the patient's family or friends.

The hospital site function 142 of the linking module 66 directs the server 12 to cause the website 33 to present one or more inputs or hyperlinks to the users 34. When activating these inputs, the server 12 transfers the users 34 to a website of the hospital 38 or to the website associated with or referred by the hospital 38. For example, if a user is looking for more information about the hospital 38, such as the hospital's staff credentials or contact information, the user can activate one of these links. Upon activation of the links, the server 12 may transfer the user to the hospital's own website where the user could access that information. Similarly, the hospital site function 142 can link the users to websites of research foundations, universities, associations or donation foundations which are associated or affiliated with the hospital 38.

The information site function 144 of the linking module 66 includes a plurality of instructions associated with websites or on-line sources which provide resources helpful to the users. These on-line sources may include, for example, information about institutions conducting research on certain diseases or illnesses, publicly available health information including information about designated diseases, information about support groups or associations for families of people with diseases, health insurance information and other on-line resources. The information site function 144 enables the users to access these on-line sources by activating one or more inputs or links at the website 33.

Referring back to FIG. 2, the production control module 68 includes a plurality of instructions associated with the process of configuring and controlling the overall operation of the website 33. The production control module 68 causes the server 12 to display one or more control panels to the implementer 14 of the website 33. Upon the implementer's activation of inputs at these control panels, the server 12 adjusts the variable settings of the computer system 10.

The session control module 70 includes a plurality of instructions associated with the operation of user sessions at the website 33. Once a user logs onto the website account, the session control module 70 causes the server 12 to perform certain activities while operating the website 33. These activities include, but are not limited to, the management of the user sessions, the management of data flow, the management of the Uniform Resource Locator (URL) transactions and the management of other operational parameters.

The implementer's contact information module 74 includes a plurality of instructions associated with the implementer's contact information. This module 74 causes the server 12 to present one or more inputs to the user at the website 33. Upon the user's activation of these inputs, the server 12 causes the website 33 to display information on how to reach the application service provider or implementer 14 by phone, email or non-electronic mail.

With continued reference to FIG. 2, the implementer's customer support module 76 includes a plurality of instructions associated with providing online, email or telephone support to the users of the computer system 10. In one embodiment, the support module 76 causes the server 12 to present one or more inputs to the users at the website 33. Upon the users' activation of these inputs, the server 12 enables the users to electronically communicate with the implementer 14.

The tips module 78 illustrated in FIG. 2 includes a plurality of instructions associated with helpful information or tips for the users 34. This module 78 directs the server 12 to present one or more inputs to the users 34 at the website 33. Upon the users' activation of these inputs, the server 21 causes the website 33 to display the tips to the users. In another embodiment, the tips modules 78 causes the tips to be displayed at the website 33 at times determined by the output control module 18.

The account termination module 80 illustrated in FIG. 2 includes a plurality of instructions associated with the termination of the website account. This account termination module 80 enables the user designated as the manager to terminate the manager's website account and to delete the webpages 32 associated with that account. The account termination module 80 causes the server 12 to display a plurality of inputs to the manager at the website 33. Upon the manager's activation of these inputs, the server 12 terminates the website account and deletes the webpages 32 associated with that account. It should be appreciated that, even after the termination of the website account, certain data may be retained. For example, part of the data provided by the users of the website account may be retained by the implementer 14 of the system 10 or by the hospital 38 subject to permission of the users and subject to applicable laws.

The email control module 82 illustrated in FIG. 2 includes a plurality of instructions associated with the control, operation and management of electronic mail. The email control module 82 causes the server 12 to present one or more inputs to the implementer 14 at the website 33. Upon the implementer's activation of these inputs, the email control module 82 directs the server 12 to enable the implementer 14 to set designated parameters for the control, batching and manipulation of email messages at the website 33.

The designated account module 84 illustrated in FIG. 2 includes at least one, and preferably a set of, modules which are associated with different types of website accounts. For example, different account modules 84 may be associated with different disease states or health conditions. Each account module 84 includes a plurality of instructions which direct the server 12 to cause the website 33 to: (a) display a distinct graphical representation designated for one of the account modules 84; and/or (b) present certain information or prompts designated for one of the account modules 84. In one example, the computer system 10 includes a labor and delivery, pregnancy or baby account module 84. This baby account module 84 includes a plurality of instructions associated with webpages 32 related to pregnancy for expecting mothers. The baby account module 84 directs the server 12 to cause the webpages 32 to display a graphical appearance or template associated with the theme of pregnancy and babies. The designated account modules 84 therefore enable the implementer 14 to adapt the website 33 to the themes of different health conditions.

The supporting page module 86 illustrated in FIG. 2 includes a plurality of instructions associated with designated webpages 32, such as home pages and about pages. The supporting page module 86 directs the server 12 to enable the implementers 14 to display these supporting pages or ancillary pages at the website 33.

### Example of Website Operation

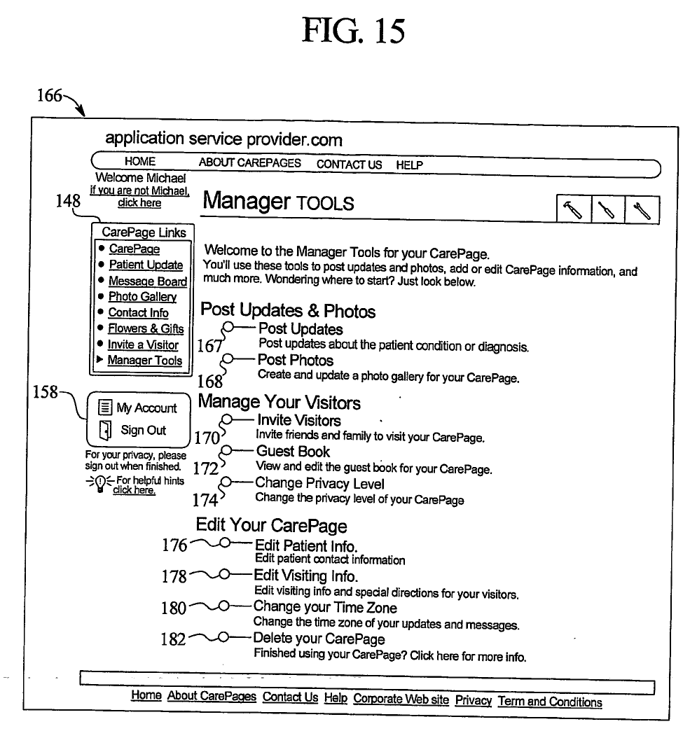

One example of the website 33 of the present invention is illustrated in FIGS. 14 to 22. In this example, the website 33 has the appearance of a website which is distinct from the Children's Memorial Hospital which is caring for the patient. It is therefore likely to be apparent to the users that the implementer 14 or application service provider is responsible for hosting and operating the website 33.

As illustrated in FIG. 14, webpage 146 displays: (a) a care page links center 148 which lists the functions of the website 33 available to the users 34; and (b) a patient update center 150 which displays certain text from the Mar. 20, 2003 update. The patient update center 150 also includes an input 152 which enables the users 34 to update additional patient information. In addition, the webpage 146 displays a photo gallery or photo center 154 which displays a photograph of the patient. In addition, the photo center 154 includes an input 156 which enables the users to view additional photographs of the patient and also upload photographs to the photo center 154. Also, the website 146 includes: (a) an account sign in and sign out center 158; (b) a message board center 160; and (c) a compliment center 162. The sign in and sign out center 158 enables the users 34 to sign into the website account and sign out of the website account. The message board 160 enables the users 34 to provide certain text and comments about the patient. The compliment center 162 presents a prompt to the users to give a compliment to a staff member of the hospital. The compliment center 162 also includes an input 164 which enables the user to begin the process of electronically sending a compliment to a staff member of the hospital.

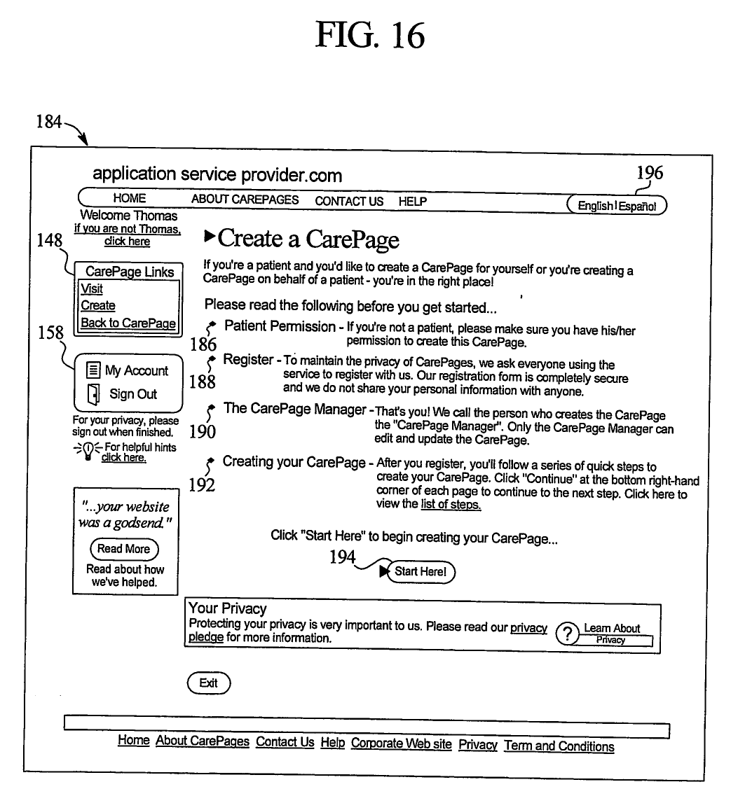

As illustrated in FIG. 15, the website 33 in this example includes a webpage 166 which is driven by the user management module 22 described above. The webpage 166 includes a plurality of inputs which enable the user who is the manager of the account to conduct certain on-line activities. In this example, the webpage 166 includes: (a) an update input 167 which enables the manager to post updates about the patient's condition or diagnosis; (b) a post photo input 168 which enables the manager to create and update a photo gallery for the patient; (c) an invite visitors input 170 which enables the manager to invite friends and family to join or become members of the website account; (d) a guestbook input 172 which enables the manager to view and edit a guestbook for the website account; (e) a change of privacy level input 174 which enables the manager to change the privacy level of the account; (f) an edit patient information input 76 which enables the manager to edit patient contact information; (g) an edit visiting information input 178 which enables the manager to edit the information and specify directions for visitors; (h) a change time zone input 180 which enables the manager to change the time zone of the updates and messages; and (i) a deletion of care page input 182 which enables the manager to terminate the website account and delete the associated webpages.

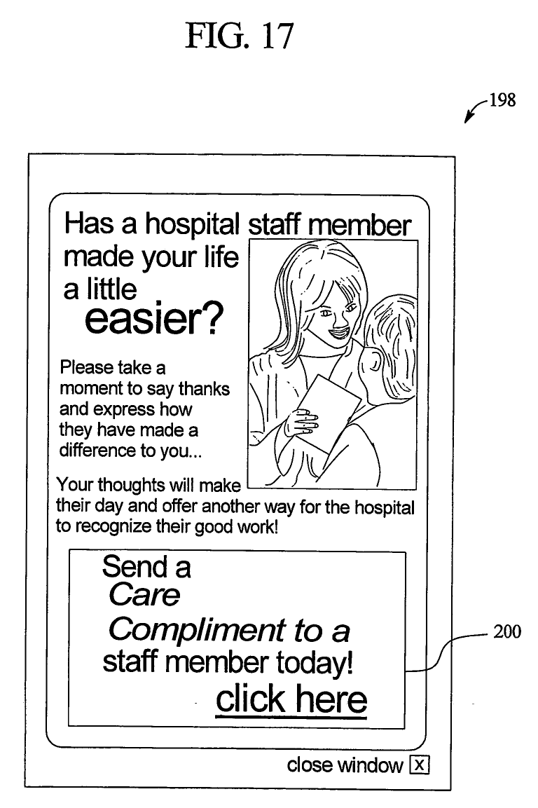

As illustrated in FIG. 16, webpage 184 provides the user with a plurality of inputs which enable the user to open a website account at the website 33. In this example, webpage 184 includes a patient permission input 186 which reminds the user to obtain the patient's permission before posting the patient's health information on the web pages 32. The webpage 184 also includes a register input 188 which facilitates the collection of certain person information from all of the users. The webpage 184 includes a care manager input 190 which enables one of the users to designate himself or herself as the manager of the website account. As described in one embodiment above, the designation of manager authorizes that user and no other user to edit the account and provide updates to the website 33. In addition, the webpage 184 includes a plurality of inputs 192 and 194 which enable the manager to set up and create the online website account. The webpage 184 also includes a translation or multi-lingual input 196 which enables the users to change the language on the website 33 from English to Spanish or vice versa.

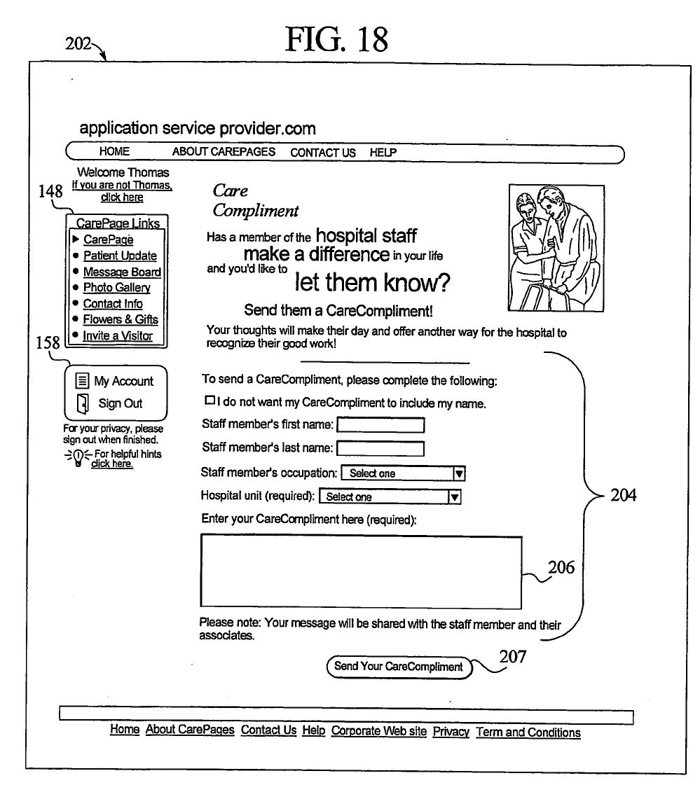

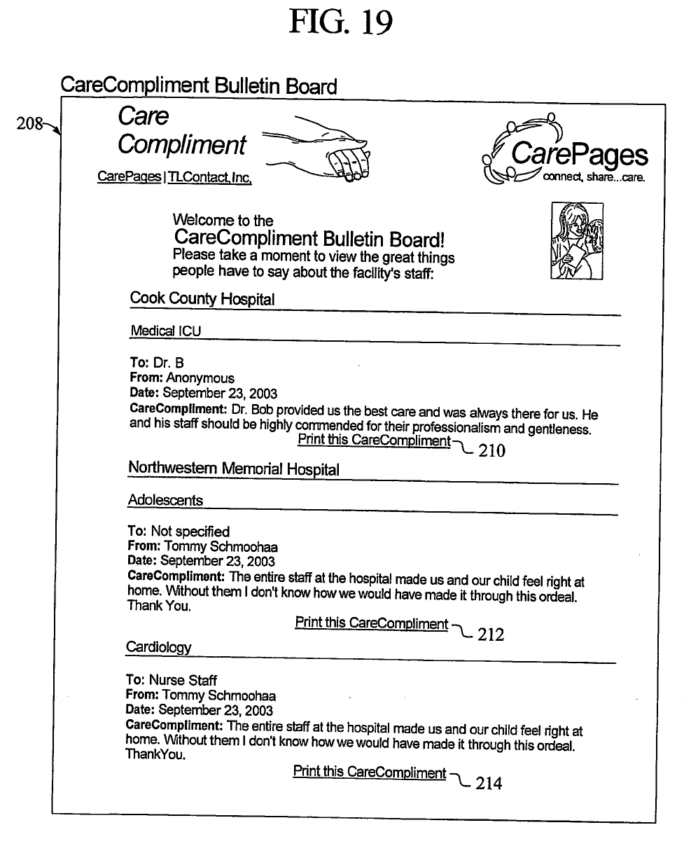

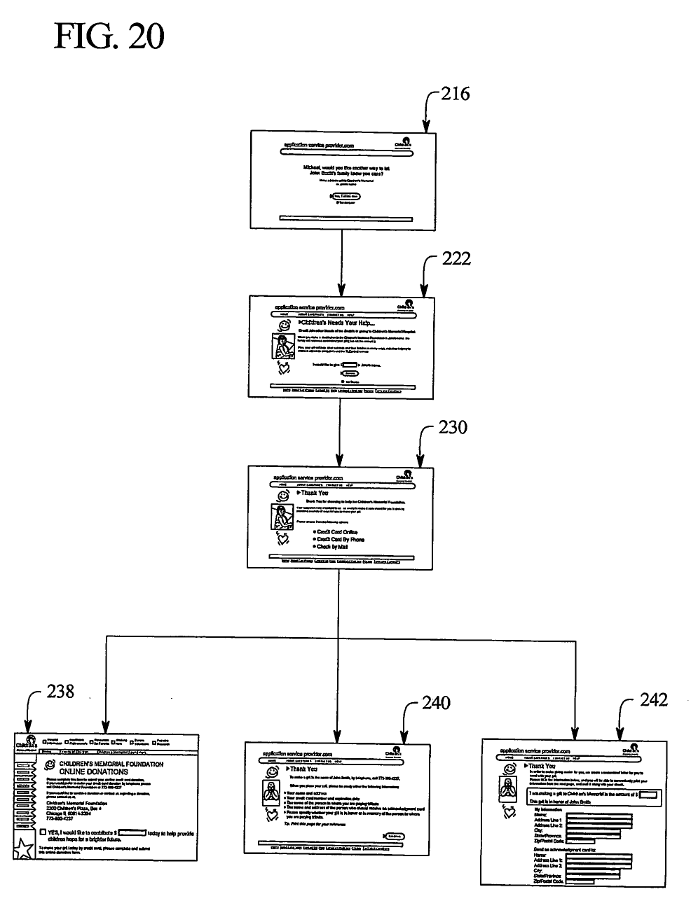

As illustrated in FIG. 17, the graphical user prompt 198 prompts the users to send a compliment to a member of the staff of the hospital. As described in one embodiment above, the computer system 10 periodically presents this prompt 198 to the users as a pop-up image. The timing of the pop-up is determined by the output control module 18 described above. In this example, the graphical user prompt 198 includes an input 200 which enables the user to send an electronic compliment to the hospital. If the user activates input 200, the computer system 10 presents the user with webpages 202 and 208 illustrated in FIGS. 18 and 19.

The webpage 202 includes a compliment entry form 204. The form 204 provides the user with a plurality of fields which the user can complete in order to provide a compliment to the hospital. In this example, the form 204 enables the user to designate: (a) whether or not the user wants to include his/her name in the compliment; (b) the staff member's first name, last name and occupation; and (c) the hospital unit associated with the staff member. The form 204 also enables the user to enter text at field 206 to create a message. In addition, the webpage 202 includes an input 207 which enables the user to electronically send the completed compliment form 204 to the hospital.

When the user sends the form 204, the hospital receives electronic mail which includes the attachment 208 illustrated in FIG. 19. In one embodiment, the computer system 10 is configured to accumulate compliments and send them as a group to the hospital at designated times. In this example, the computer system 10 sent three different compliments to a designated address of a private area network or intranet of the hospital. The server 12 transmits the compliments directly to the hospital's server which operates the hospital's intranet. Accordingly, the compliments are displayed at the care compliment bulletin board of the hospital's intranet. Designated staff at the hospital can view the various compliments at once and print desired compliments by activating inputs 210, 212 and 214.

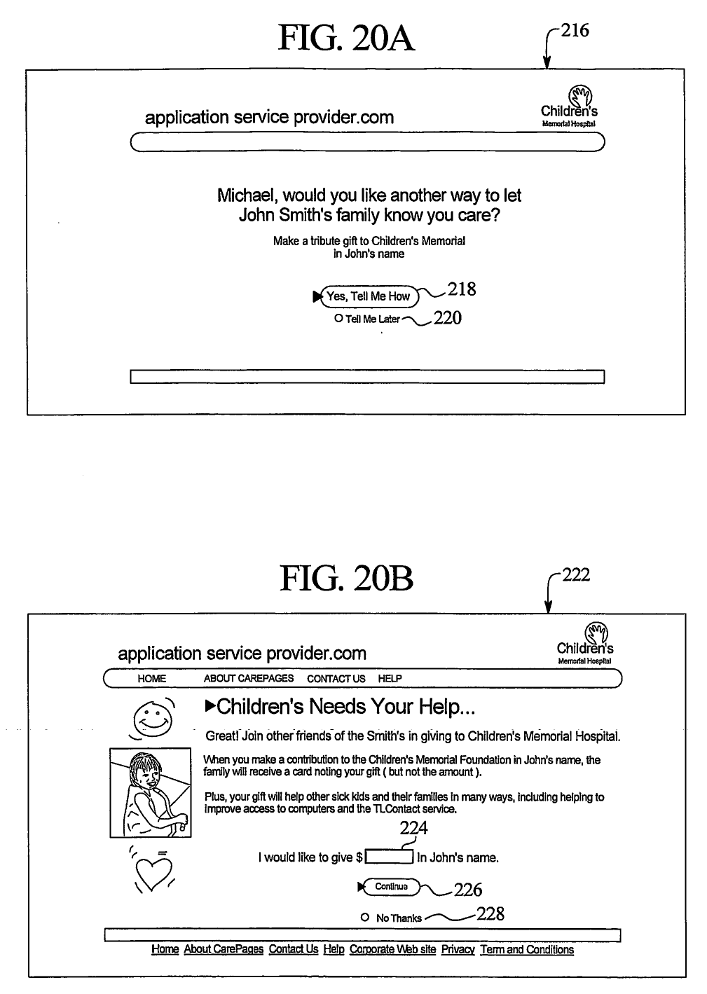

Continuing with this example of the website 33, FIGS. 20 and 20A-20F illustrate the operation of the donation module 16 of the present invention. At times determined by the output control module 18, the computer system 10 presents the user with a graphical donation prompt 216 at the website 33. The donation prompt 216 prompts the user to make a donation to the hospital. The user can proceed with the donation process by activating input 218, or the user may decline by activating input 220.

If the user activates the input 218, the computer system 10 presents the user with webpage 222. The webpage 222 provides the user with information about the benefits and advantages of providing a donation to the hospital. In this example, the webpage 222 notifies the user that, when making a donation, the family of the patient will receive a card noting the gift. The webpage 222 also states that the donation will be used to help provide access to the online service of the website 33. In addition, the webpage 222 includes a field 224 which enables the user to input a monetary amount for the donation. Also, the webpage 222 includes an input 226 which enables the user to proceed with the donation, and the webpage 222 includes an input 228 which enables the user to decline the donation.

If the user activates the input 226, the computer system 10 presents the user with webpage 230. The webpage 230 provides information which thanks the user for the donation and also provides the user with a plurality of payment options or inputs 232 to 236. The user can pay on-line by credit card by activating the input 232. The user can pay over the phone by credit card by activating the input 234, or the user can pay by regular mail by activating the input 236.

If, instead, the user activates the online input 232, the website 33 displays webpage 238. The website 238 provides the user with a plurality of fields and inputs which enable the user to make a relatively secure credit card payment at the hospital's website. If the user activates the phone input 234, the website 33 displays webpage 240 to the user. The webpage 240 provides the user with a telephone number and other information associated with making an online payment by phone.

If the user chooses to activate the mail input 236, the website 33 displays webpage 242. The webpage 242 includes a plurality of fields which enable the user to create and print letterheads having designated information. The user can send this letter along with the payment to the hospital, and the hospital can provide the letter to the patient or the patient's family.

### Portal Embodiment

In one embodiment, the computer system 10 of the present invention includes one or more portal modules enabling the involvement of entities other than the facility-related organizations 38. Such entities are at times referred to herein as facility independent entities. Therefore, this embodiment involves at least three separate entities—(a) a facility independent entity; (b) a facility-related organization 38, such as a hospital; and (c) the implementer of the present invention.

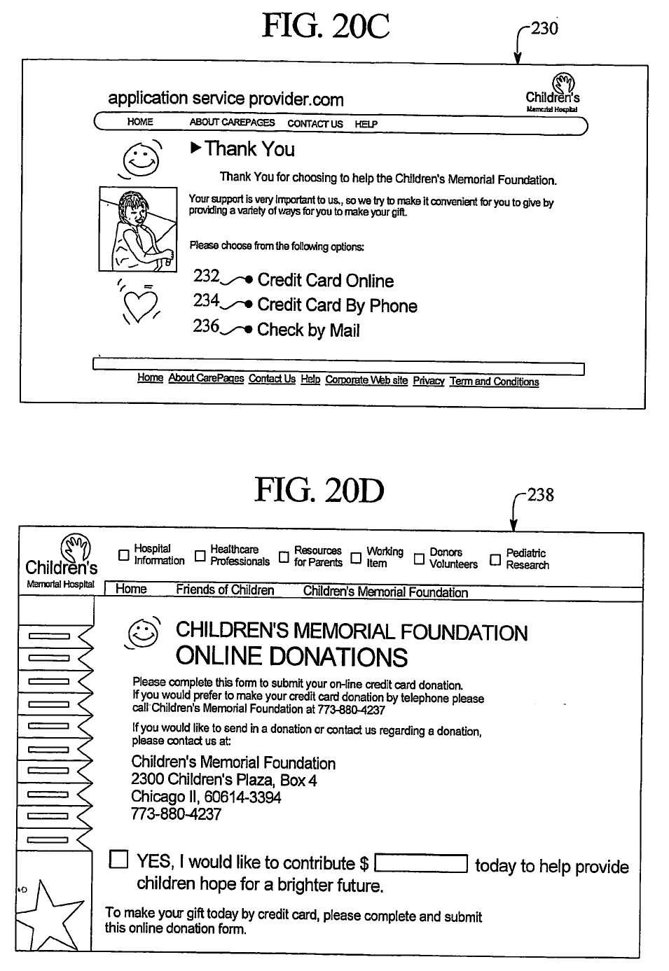

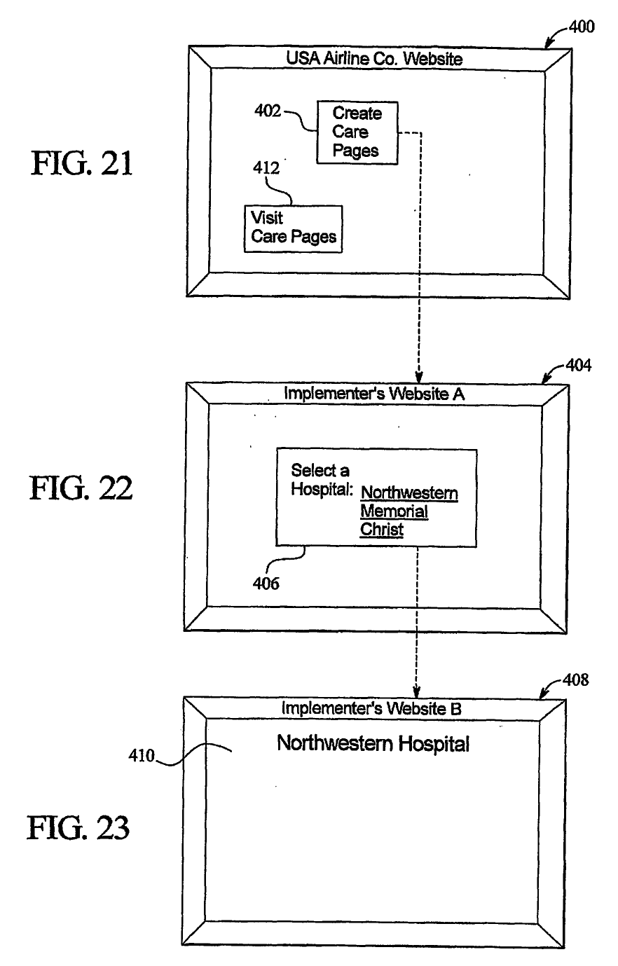

In one example of this embodiment illustrated in FIGS. 21-23, the portal module is used in conjunction with the website 400 of the non-hospital entity, USA Airline Co. The portal module includes a plurality of instructions which direct the one or more servers 12 to present an input or link 402 at the website 400. The link 402 prompts the users, such as the employees of USA Airline Co., to create health care webpages or a website account by activating the link 402. The employees may wish to create a set of health care or care webpages for hospitalized family members or friends for the purposes described above.

If an employee activates the link 402, the portal module redirects the employee's browser to a portal website 404 which is hosted by the one or more servers 12. The portal website 404 presents one or more inputs 406 to the employee. By activating this input 406, the system 10 enables the employee to select a hospital from a list of hospitals. In the illustrated example, the employee's daughter is hospitalized at Northwestern Hospital, so the employee used input 406 to select Northwestern Hospital.

After making this selection, the portal module redirects the employee's browser to a care website 408. The care website 408, hosted by one or more servers 12, has the same or substantially the same functionality as website 33 described above. Therefore, the system 10 enables the employee to use the website 408 to create a set of webpages 410 for posting, maintaining, updating and sharing information about his/her hospitalized daughter with family and friends.

It should be appreciated that the portal module enables each employee to create a plurality of sets of webpages for a plurality of different hospitalized patients. For example, an employee of USA Airline Co. may create a set of webpages for his/her hospitalized daughter, and the same employee may create a set of webpages for a hospitalized cousin.

As described earlier, the system 10 enables a plurality of groups or communities of users or members (other than the employee) to access these sets of webpages in order to obtain information about their hospitalized family members and friends. The portal module enables the members to access the webpages 410 by: (a) activating a designated input 412 at the website 400 of USA Airline Co.; (b) activating a designated input at a website operated by the implementer of the present invention; or (c) activating any other designated input or link including a URL for a particular set of webpages 410.

If the members access the set of webpages 410 through the website 400 of USA Airline Co., the members will view the branding, marketing and promotional materials and information presented by USA Airline Co. at its website 400. Next, the members will access additional branding, marketing and promotional materials and information presented by USA Airline Co. at the portal website 404. Finally, the members will access the branding, marketing and promotional materials and information presented by Northwestern Hospital at the website 408.

If the members access the set of webpages 410 through a designated input or link other than the input 412, the portal module directs the members to the portal website 404. While at website 404, the members will be exposed to the branding, marketing and promotional materials and information of USA Airline Co. presented at the website 404.

Accordingly, the portal module provides facility-independent companies and entities with a method and tool for operating a business, promoting a business and conducting advertisement activities. In one embodiment, the method includes the steps of:

(a) providing and operating a company website;

(b) enabling employees and other users to access the company website;

(c) presenting information at the company website which promotes the products or services of the company;

(d) coupling a designated link at the company website to a portal website;

(e) enabling the users to activate such designated link at the company website;

(f) causing information to appear at a portal website wherein such information promotes the products or services of the company;

(g) directing the users to the portal website upon activation of the designated link, wherein the portal website:

a. enables the users to select a health-care facility from a group of health care providers;

b. enables the users to activate a link available at the portal website;

c. directs the users to a care website thereby enabling the users to create a set of webpages associated with a person residing at the health care facility and also enabling the users to invite a plurality of other users to visit the webpages; and

(h) requiring the users to visit the company website or the portal website in order to access such webpages.

The portal module, in function, also provide the implementer of the present invention with a method for assisting companies in promoting their businesses. This method, in one embodiment, includes the steps of:

(a) providing a company's website with a link to a portal website hosted by the implementer;

(b) presenting information at the portal website pertaining to the company's products or services;

(c) enabling users who activate the link to visit the portal website;

(d) enabling the users to select a health care facility from a group of health care providers while at the portal website;

(e) enabling the users to activate a link available at the portal website;

(f) directing the users to a care website;

(g) enabling the users to create a set of webpages at the care website associated with a person residing at the selected health care facility;

(h) enabling the users to invite a plurality of other users to visit the webpages; and

(i) requiring the users to visit the company website or the portal website in order to access the webpages.

These methods provide several advantages. One advantage is an increase in the visibility, good will and name recognition of the implementer's service. This is because the website 408 service is made known to all of the visitors of the website 400 of USA Airline Co. In order to increase promotion, in one embodiment, the company website 400 includes a branding or marketing indicator, such as “Powered by Implementer,” positioned adjacent to the link 412. Another advantage of the portal module is an increase in consumer traffic to the on-line promotional materials of companies.

It should be appreciated that the portal module enables users to create webpages 410 for others and for themselves. In one embodiment, the system enables the users to create webpages 410 pertaining to their own health status, such as a history of blood-pressure, medication, illnesses or other medical conditions. The users can access and use these records on-line, and the users can authorize family members and others to access their medical records.

In one embodiment, the portal module includes a plurality of sub-modules or functionalities, including: (a) a bulletin board or chat room sub-module accessible at the company website 400 or the portal website 404; (b) an interface at the website 400 or 404 that provides discussion forums about health topics open to all users; and (c) one or more interfaces at the website 400 or 404 providing: (i) user-targeted content about health topics such as specialty services with topics such as Finding Clinical Trials, Travel Health Advisory, Health Insurance, and Life Basics; (ii) Health & Wellness subject matter with topics such as Nutrition, Fitness, Women's Health, Pregnancy & Family, Children's Health, Men's Health, Disease Management and Drug Information; (iii) Emotional Support subject matter with topics such as Mental Health, Support Groups, Spiritual Health, Grief & Bereavement, Volunteer Opportunities and Community Events; and (iv) Hospitalization Basics subject matter with topics such as What to Expect, Talking with Your Doctor, Taking Your Meds, Ensuring Your Safety, Healing/Recovering, Discharge Planning, Coming Home and Patient Advocacy. In one embodiment, the portal module also has a shopping functionality, enabling users to shop for or purchase medical related products and services tied to a rewards program.

The present invention, in one embodiment, includes a computer system for operating a website which enables users to exchange information about relocated persons, such as hospitalized family or friends. The website also enables organizations, such as hospitals, to exchange information with the users, solicit donations from the users and generally promote their organizations. In one embodiment, the computer system includes an output control module which controls the timing of certain activities which occur at the website. In order to increase user response, this module causes the website to display donation solicitations and survey opportunities at times based on the user's history of inputs. This type of computer system assists users in staying up-to-date on the conditions of relocated persons and provides organizations with a communication channel for service enhancement, promotional and donation purposes.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A computer system for assisting users, associated with a resident of a health care facility, in: (a) sharing information related to a health condition of the resident; and (b) providing donations which are at least partially receivable by the health care facility, the computer system comprising:
a plurality of instructions which direct a processor operating on a wide area network to:
(a) control a graphical user interface which is accessible to a plurality of users over the network;
(b) cause the graphical user interface to present donation information to the users, the donation information providing the users with direction on making a donation to: (i) the health care facility; or (ii) an entity other than the health care facility, the entity having a purpose to raise donations which are at least partially receivable by the health care facility;
(c) enable at least one of the users to present information related to the resident's health condition, the information being available to the other users on the graphical user interface;
(d) enable the users to electronically deliver information to an electronic address of the health care facility; and
(e) enable the health care facility to electronically deliver information to each of the users, the information being accessible to the users at a designated portion of the graphical user interface.

2. The computer system of claim 1, wherein the instructions include at least one instruction which directs the processor to produce a plurality of outputs which vary with different historical patterns of inputs made by each of the users.

3. The computer system of claim 2, wherein the outputs include a prompt selected from the group consisting of a prompt to make a donation to the health care facility or the entity, a prompt to complete a survey of the health care facility, and a prompt to electronically deliver a compliment to at least one of the health care providers.

4. The computer system of claim 1, wherein the instructions include at least one instruction which directs the processor to automatically present designated communications from the health care facility to the users when designated events occur, the designated communications being accessible to the users on the graphical user interface.

5. The computer system of claim 1, wherein the instructions include at least one instruction which directs the processor to enable a designated one of the users to control the other users' access to the graphical user interface.

6. The computer system of claim 1, wherein the instructions include at least one instruction which directs the processor to activate at least one security function before providing the users with access to designated information.

7. The computer system of claim 1, wherein the instructions include at least one instruction which directs the processor to enable the health care facility to customize designated functions accessible on the graphical user interface.

8. The computer system of claim 1, wherein the instructions include at least one instruction which directs the processor to cause text on the graphical user interface to be selectively presented in a plurality of different human languages.

9. The computer system of claim 1, wherein the instructions include at least one instruction which directs the processor to cause help information to be accessible on the graphical user interface.

10. The computer system of claim 1, wherein the instructions include at least one instruction which directs the processor to produce a report based on information provided by the users.

11. The computer system of claim 1, wherein the instructions include at least one instruction which directs the processor to enable at least one of the users to present a photograph of the resident on the graphical user interface.

12. The computer system of claim 1, wherein the instructions include at least one instruction which directs the processor to cause the graphical user interface to have a graphical scheme which is substantially similar to a graphical scheme of a graphical user interface of the health care facility.

13. The computer system of claim 1, wherein the instructions include at least one instruction which directs the processor to cause the graphical user interface to present an input to each of the users wherein activation of said input transfers the user to a location on the network where the user can make a payment to the health care facility or the entity over the network.

14. The computer system of claim 13, wherein the instructions include at least one instruction which directs the processor to: (a) receive donation information from a processor of the health care facility or the entity after each of the users makes a donation over the network; and (b) upon receiving the donation information, cause a notice to be provided to a designated person associated with the resident.

15. The computer system of claim 14, wherein the notice includes an identity of the user that made the donation.

16. The computer system of claim 15, wherein the notice includes mail selected from the group consisting of electronic mail, nonelectronic mail and voice mail.

17. The computer system of claim 16, wherein the mail includes a gift from the user that made the donation.

18. The computer system of claim 1, wherein the instructions include at least one instruction which directs the processor to enable each of the users to make a payment to the health care facility or the entity over the network.

19. The computer system of claim 1, wherein the donation information includes a telephone number usable by the users to make a payment to the health care facility or the entity over the phone.

20. The computer system of claim 1, wherein the donation information includes a mailing address usable by the users to mail a payment to the health care facility or the entity.

21. The computer system of claim 1, wherein the instructions include at least one instruction which directs the processor to enable each of the users to electronically deliver an invitation to an electronic address of at least one nonuser, the invitation including information related to the graphical user interface related to the resident.

22. The computer system of claim 1, wherein the instructions include at least one instruction which directs the graphical user interface to present an input to at least one of the users wherein activation of said input enables the user to electronically deliver a message to an electronic address of the health care facility, the message including a compliment to a person who has provided services to the resident.

23. The computer system of claim 1, wherein the instructions include at least one instruction which directs the processor to cause the graphical user interface to present an input to at least one of the users wherein activation of said input enables the user to cause the graphical user interface to present complimenting information related to services provided to the resident.

24. The computer system of claim 1, wherein the instructions include at least one instruction which directs the processor to cause the graphical user interface to present an input to at least one of the users wherein activation of said input enables the user to electronically complete a survey of the health care facility, whereafter, at least one of the instructions directs the processor to electronically deliver the completed survey to an electronic address of the health care facility.

25. The computer system of claim 1, wherein the instructions include at least one instruction which directs the processor to cause the graphical user interface to present an input to at least one of the users wherein activation of said input enables the user to electronically deliver a complaint to an electronic address of the health care facility.

26. The computer system of claim 1, wherein the instructions include at least one instruction which directs the processor to cause the graphical user interface to present a designated electronic letter from the health care facility to each of the users.

27. The computer system of claim 1, wherein the instructions include at least one instruction which directs the processor to cause the graphical user interface to present a survey of the health care facility to each of the users.

28. A computer system for assisting users, associated with a patient of a hospital, in: (a) sharing information related to a health condition of the patient; and (b) providing donations which are at least partially receivable by the hospital, the computer system comprising:
a plurality of computer-readable instructions which direct a server operating on an internet to:
(a) operate a website accessible to a plurality of internet access devices;
(b) cause the website to present donation information to the users, the donation information providing the users with direction on making a donation to: (i) the hospital; or (ii) an entity other than the hospital, the entity having a purpose to raise donations which are at least partially receivable by the hospital;
(c) cause the website to automatically present the donation information to the users in accordance with a time scheme based on a historical pattern of inputs made by each of the users at the website;
(d) enable at least one of the users to present information related to the patient's health condition, the information being available to the other users at the website;
(e) enable the users to electronically deliver information to an electronic address of the hospital; and
(f) enable the hospital to electronically deliver information to each of the users, the information being accessible to the users at a designated portion of the website.

29. The computer system of claim 28, wherein the instructions include at least one instruction which directs the server to enable at least one of the users to present a photograph of the patient which is accessible at the website.

30. The computer system of claim 28, wherein the instructions include at least one instruction which directs the server to cause the website to have a graphical scheme which is substantially similar to a graphical scheme of a website of the hospital.

31. The computer system of claim 28, wherein the instructions include at least one instruction which directs the server to cause the website to present an input to at least one of the users wherein activation of said input enables the user to electronically deliver a message to an electronic address of the hospital, the message including a compliment to a person who has provided services to the patient.

32. The computer system of claim 28, wherein the instructions include at least one instruction which directs the server to cause the website to present a survey of the hospital to each of the users.

33. A method for use in operating a health care facility, the method comprising:
(a) enabling a visitor of a resident of the health care facility to open a website account associated with a website;
(b) enabling the visitor to provide access to the website account to a select group of users;
(c) enabling the visitor to make health condition information of the resident accessible to the users at the website;
(d) periodically and automatically presenting opportunities for the users to make donations to the health care facility or an entity affiliated with the health care facility while the users are using the website;
(e) periodically and automatically presenting opportunities for the users to complete surveys of the health care facility while the users are using the website;
(f) enabling the users to electronically deliver compliments to health care providers who provide services to the resident; and
(g) enabling the health care facility to provide electronic mail to the users by delivering the mail to at least one in-box accessible at the website.

34. The method of claim 33, wherein step (a) includes the step of enabling a visitor of a patient of a hospital to open a website account.

35. The method of claim 33, wherein steps (d) and (e) each include the step of determining a timing for presenting the opportunities based-on a historical pattern of inputs made by the users at the website.

36. A method for soliciting donations receivable, at least in part, by a health care facility, the method comprising:
(a) enabling a visitor of a resident of the health care facility to open a website account associated with a website;
(b) enabling the visitor to provide access to the website account to a select group of users;
(c) enabling the visitor to make health condition information of the resident accessible to the users at the website; and
(d) presenting opportunities for the users to make donations to the health care facility or an entity affiliated with the health care facility while the users are using the website.

37. The method of claim 36, wherein step (a) includes the step of enabling a visitor of a patient of a hospital to open a website account.

38. The method of claim 36, wherein step (d) includes the step of determining a timing for presenting the opportunities based on a historical pattern of inputs made by the users at the website.

39. A computer system for facilitating communications and financial contributions related to a circumstance of a resident of at least one multi-resident facility, the multi-resident facility being used by an organization to support the resident, the computer system comprising:
a plurality of instructions which direct a processor operating on a network to:
(a) control a graphical user interface which is accessible to a plurality of users over the network;
(b) cause the graphical user interface to present financial contribution information to the users, the financial contribution information providing the users with direction on how to make a financial contribution to: (i) the organization; or (ii) an entity other than the organization, the entity having a purpose to raise donations for use related to the resident's circumstance;
(c) produce a plurality of outputs which vary with different historical patterns of inputs made by each of the users;
(d) enable at least one of the users to present information related to the resident's circumstance, the information being available to the other users on the graphical user interface;
(e) enable the users to electronically deliver information to an electronic address of the organization;
(f) automatically present designated communications from the organization to the users when designated events occur, the designated communications being accessible to the users on the graphical user interface;
(g) enable the organization to electronically deliver communications to each of the users, the information being accessible to the users at a designated portion of the graphical user interface;
(h) enable a designated one of the users to control the other users' access to the graphical user interface; and
(i) activate at least one security function before providing the users with access to designated information.

40. The computer system of claim 39, wherein the organization is selected from the group consisting of a health care provider, a military unit, a college, a university, an education provider and a recreation provider.

41. The computer system of claim 39, wherein the outputs include a prompt selected from the group consisting of a prompt for each of the users to make a financial contribution to the organization or the entity, a prompt for each of the users to complete a survey of the organization, and a prompt for each of the users to electronically deliver a compliment to at least one of the organizations.

42. The computer system of claim 39, wherein the instructions include at least one instruction which causes the graphical user interface to present an input to each of the users wherein activation of said input transfers the user to a location on the network where the user can make a payment to the organization or the entity over the network.

43. The computer system of claim 39, wherein the instructions include at least one instruction which enables each of the users to make a payment to the organization or the entity over the network.

44. A method for use by an organization which operates a facility for a plurality of residents, the method comprising:
(a) enabling a visitor of one of the residents of the facility to open a website account associated with a website;
(b) enabling the visitor to provide access to the website account to a select group of users;
(c) enabling the visitor to make information about the resident accessible to the users at the website;
(d) periodically and automatically presenting opportunities for the users to make financial contributions to the organization or an entity affiliated with the organization while the users are using the website;
(e) periodically and automatically presenting opportunities for the users to provide information to organization while the users are using the website; and
(f) enabling the organization to provide electronic mail to the users by delivering the mail to at least one in-box accessible at the website.

45. The method of claim 45, wherein steps (d) and (e) each include the step of determining a timing for presenting the opportunities based on a historical pattern of inputs made by the users at the website.

46. The method of claim 45, which includes the step of enabling the users to make an electronic payment to the organization or the entity by using the website.
